(19) United States
(12) Patent Application Publication
(10) Pub. No.: US 2013/0342039 A1
(43) Pub. Date: Dec. 26, 2013

(54) Switched Reluctance Motor and Switched Reluctance Motor Drive System

(71) Applicants: Takashi UMEMORI, Kamakura-shi (JP); Makoto Tanaka, Yokohama-shi (JP)

(72) Inventors: Takashi UMEMORI, Kamakura-shi (JP); Makoto Tanaka, Yokohama-shi (JP)

(73) Assignee: EV Motor-Systems Co., Ltd, Minami-ku (JP)

(21) Appl. No.: 13/529,620

(22) Filed: Jun. 21, 2012

(51) Int. Cl. H02K 19/10

(52) U.S. Cl. 310/49.43

(57) ABSTRACT

A regenerative switched reluctance motor and a motor drive system therefor are provided. The motor has a rotor 33 with stacked rotor units 33a-33d each comprising 2n salient poles and a stator 31 with stacked stator units 31a-31d surrounded by and corresponding to the rotor units and each comprising 4n magnetic poles to form a predetermined gap with the salient poles of the corresponding rotor unit. A first excitation coil 32(A) is wound on every other one of the 4n magnetic poles of each stator unit, while a second excitation coil 32(B) is wound on the remaining magnetic poles thereof. The rotor units are sequentially shifted by a predetermined angle in angular position relative to the stator units. The switched reluctance motor and the motor drive system can efficiently drive the motor and recover regenerative power with little torque ripple and noise.

### BACKGROUND OF THE INVENTION

1. Field of the Invention

The present invention relates to a switched reluctance motor comprising a rotor having a plurality of salient poles and a stator which is arranged inside the rotor and has salient portions with excitation coils wound thereon to form a plurality of magnetic poles, and also relates to a switched reluctance motor drive system for sequentially supplying current to the excitation coils so as to rotate the rotor arranged outside the stator.

2. Description of the Related Art

Conventionally, in widely known electric motor drive systems, there are (1) those comprising a PWM (Pulse Width Modulation) inverter and a three-phase synchronous motor, and (2) those comprising a PWM inverter and a three-phase induction motor. They were proposed in the 1960s and 1970s, and have been widely used in elevators, street cars, cranes, air conditioners, electric cars, hybrid cars and so on as power electronics and electronic circuit technology have advanced. The wide use of such electric motor drive systems is due to their better controllability compared to classical electric motor drive systems. However, in recent years, the importance of reduction in CO₂ emissions and rare earth resource has been recognized, so that the use of the conventional electric motor drive systems, as they are, causes the following problems.

Synchronous motors use neodymium magnets, the resources of which are present only in certain countries and which are too small in volume to be used in all electric motors as drive sources for electric cars of the world. On the other hand, induction motors have disadvantages in weight and efficiency, in which the efficiency is further reduced by high frequency components of pseudo sine wave generated by a PWM inverter. In addition, the induction motors require high level technology for regenerative braking. In order to significantly reduce CO₂ emissions, it is required not only to improve the efficiency of the electric motor drive systems in all fields, including popularizing electric cars, but also to increase, as much as possible, energy recovery when braking. It is important for the electric motor drive systems to have little limitation in resources so as to allow them to be used worldwide.

The present invention departs from the conventional motor drive systems which basically use a three-phase synchronous motor or a three-phase induction motor, and proposes a new motor drive system basically using a reluctance motor (refer e.g. to Japanese Laid-open Patent Publication No. 2007-312562). Conventional reluctance motors have problems of low efficiency, high weight and difficulty in regenerative braking as well as large torque ripple, vibration and noise. These problems are due to the inherently high reluctance of the coils of the reluctance motors, which causes difficulty in quickly controlling current, which in turn causes difficulty in supplying each coil with a current having an advantageous waveform in view of torque variations. Further, while in the excitation coil a primary current to generate attractive force is superimposed on a regenerative current when regenerative braking, it is difficult to control to effectively separate and recover the regenerative current to a power supply. In addition, the attractive force exerts inward force on an outer frame, which causes vibration and noise.

### BRIEF SUMMARY OF THE INVENTION

It is an object of the present invention to provide a switched reluctance motor and a switched reluctance motor drive system which can efficiently drive the motor and can recover regenerative power with little torque ripple and noise.

According to a first aspect of the present invention, the object is achieved by a regenerative switched reluctance motor comprising a stator and a rotor surrounding the stator, wherein the rotor comprises a plurality of coaxially stacked rotor units, wherein the stator comprises a plurality of coaxially stacked stator units facing and corresponding to the plurality of rotor units, wherein each of the plurality of rotor units comprises 2n (n: integer) salient poles arranged at predetermined angular intervals, wherein each of the plurality of stator units comprises 4n magnetic poles arranged at predetermined angular intervals such that the magnetic poles of each of the plurality of stator units and the salient poles of the corresponding each of the rotor units form a predetermined gap therebetween, wherein a first excitation coil is wound on every other one of the 4n magnetic poles of each of the plurality of stator units, while a second excitation coil is wound on the remaining magnetic poles thereof, and wherein the plurality of rotor units are sequentially shifted by a predetermined angle in angular position relative to the plurality of stator units.

According to a second aspect of the present invention, the above object is achieved by a switched reluctance motor drive system comprising the regenerative switched reluctance motor according to the first aspect of the present invention, and further comprising: a DC constant current power supply unit having multiple output terminals to output a constant DC current from one of the multiple output terminals; a plurality of current switching circuits which are provided respectively corresponding to the plurality of stator units, and each of which comprises a first current path and a second current path to be switched; and switch control means for controlling the plurality of current switching circuits so as to alternately turn on the first current path and the second current path of each of the plurality of current switching circuits, wherein the plurality of current switching circuits are series-connected while the first current path and the second current path of each of the plurality of current switching circuits are respectively connected in series with the first excitation coil and the second excitation coil of the corresponding one of the plurality of stator units, wherein the DC constant current power supply unit, the plurality of current switching circuits and the switched reluctance motor are connected so that the constant DC current output from the one of the multiple output terminals of the DC constant current power supply unit is input to the first and second current paths of one of the series-connected current switching circuits, which is located at the first stage of the current switching circuits, and flows through the first excitation coil connected to the first current path and the second excitation coil connected to the second current path of another one of the series-connected current switching circuits, which is located at the final stage of the current switching circuits, and is then fed back to another one of the multiple output terminals, and wherein the switch control means alternately performs on/off operations of the first and second current paths of each of the plurality of current switching circuits according to the angular position of the rotor of the switched reluctance motor so as to allow a current to alternately flow in the first excitation coil and the second excitation coil, and controls each of the plurality of current switching circuits so as to shift timing of the on/off operations of the first and second current paths, between when driving the switched reluctance motor and when braking the switched reluctance motor, by a time during which the rotor is rotated by an angle corresponding to an electrical angle of 180°.

The switched reluctance motor according to the first aspect of the present invention makes it possible that by sequentially supplying a current at predetermined shifted timings to the first excitation coil and the second excitation coil wound alternately on every other one of the magnetic poles of each of the stator units forming the stator when driving the switched reluctance motor, the 2n salient poles of each of the rotor units forming the rotor unit arranged outside the stator can be sequentially attracted by the excited magnetic poles of the corresponding stator units so as to rotate the rotor. Thus, it is possible to efficiently drive the switched reluctance motor with little torque ripple and noise.

In addition, the structure of the switched reluctance motor according to the present invention, in which the rotor is arranged outside the stator, is suitable as a so-called in-wheel motor of an electric car, making it possible to particularly obtain the following effects. It is possible to arrange the gap (magnetic pole air gap) between each magnetic pole of each stator unit and each salient pole of each rotor unit at a more outside location, making it possible to increase the effective turning radius of the switched reluctance motor to reduce the efficiency drop when driven at a low speed. As a result, it can be driven at a low speed with a gearless system. Furthermore, by arranging the magnetic pole air gap at a more outside location, it is easier to form a multi-pole structure and reduce the cross-sectional area of the yoke for lighter weight. Assuming that the switched reluctance motor of the present invention is applied to an electric car, it can be easily used as a gearless in-wheel motor by integrating the rotor with a wheel rim.

The switched reluctance motor drive system according to the second aspect of the present invention makes it possible that by sequentially supplying a current at predetermined shifted timings to the first excitation coil and the second excitation coil wound alternately on every other one of the magnetic poles of each of the stator units forming the stator when driving the switched reluctance motor, the 2n salient poles of each of the rotor units forming the rotor unit can be sequentially attracted by the excited magnetic poles of the corresponding stator units so as to rotate the rotor. When braking the switched reluctance, this switched reluctance motor drive system also makes it possible to feed back, to the DC constant current power supply unit, a current which is superimposed on the constant DC current supplied to the first and second excitation coils wound on the magnetic poles of the stator units, and which corresponds to change in area of the magnetic poles opposing the salient poles of the corresponding rotor units. Thus, it is not only possible to drive the switched reluctance motor, but also to recover regenerative power.

Preferably, the current to alternately flow in the first excitation coil and the second excitation coil is a rectangular-wave current. This makes it possible to effectively perform the sequential current supply to the first excitation coil and the second excitation coil.

Preferably, n is at least 2, so that each of the plurality of rotor units has at least 4 salient poles, while each of the plurality of stator units has at least 8 magnetic poles. This is preferable for higher uniformity of the attractive force generated between the salient poles and the magnetic poles, and for less vibration and noise of the switched reluctance motor when driving.

Further preferably, the predetermined angle is a quotient of an angular pitch of the magnetic poles of each of the plurality of stator units divided by the number of the rotor units. This allows the multiple ones of the rotor units to serve for one pitch of the magnetic poles of the stator units in each of the rotor units to sequentially receive an attractive force, allowing smoother rotation of the switched reluctance motor.

In order to sequentially shift the plurality of rotor units by a predetermined angle in angular position relative to the plurality of stator units, the plurality of rotor units can be in the same angular position while sequentially shifting the plurality of stator units one after another in angular position by the predetermined angle, or the plurality of stator units can be in the same angular position while sequentially shifting the plurality of rotor units one after another in angular position by the predetermined angle.

Further preferably, the width of each of the salient poles of each of the plurality of rotor units in the direction of rotation is set to be larger than the width of each of the magnetic poles of the corresponding each of the stator units. This width relationship of each salient pole and each corresponding magnetic pole reduces a period of time during which each salient pole is prevented from facing the magnetic poles of the corresponding stator unit, thereby reducing a period of time during which the attractive force exerted by each magnetic pole on the salient poles of the corresponding rotor unit is reduced, so that the torque ripple and vibration of the switched reluctance motor can be reduced.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is a schematic block diagram showing a basic structure of a switched reluctance motor drive system according to an embodiment of the present invention;

FIG. 2A is a schematic axial cross-sectional view of a basic structure of a switched reluctance motor according to an embodiment of the present invention along the axis of a supporting shaft;

FIG. 2B is a schematic cross-sectional view of the switched reluctance motor along line A-A′ of FIG. 2A;

FIGS. 3A to 3D are schematic views showing an example of arrangement of four sets of the stator units and the corresponding rotor units, that are a set of the first stator unit with the first rotor unit, a set of the second stator unit with the second rotor unit, a set of the third stator unit with the third rotor unit, and a set of the fourth stator unit with the fourth rotor unit, respectively, in which the four stator units are in the same angular position relative to the supporting shaft, while the four rotor units are sequentially shifted in angular position in the opposite direction of rotation by a predetermined angle relative to the corresponding four stator units;

FIGS. 4A to 4D are schematic views showing another example of arrangement of four sets of the first to fourth stator units and the corresponding first to fourth rotor units, respectively, similarly as in FIGS. 3A to 3D, except that in FIGS. 4A to 4D, the four rotor units are in the same angular position relative to the supporting shaft, while the four rotor units are sequentially shifted in angular position in the direction of rotation by a predetermined angle relative to the corresponding four stator units;

FIG. 5 is a schematic view showing relationship between A-phase and B-phase excitation coils wound on each of the stator units as well as generated magnetic flux;

FIG. 6 is a schematic circuit diagram of an example of a current switching device;

FIG. 7A is a timing chart showing an operation of first and second switching elements in the current switching device when driving the switched reluctance motor;

FIG. 7B is a timing chart showing an operation of the first and second switching elements in the current switching device when braking the switched reluctance motor;

FIG. 8 is a schematic simplified view showing a DC constant current power supply unit and a constant current flip-flop circuit forming a current switching device (current switching circuit);

FIG. 9 is a waveform diagram showing waveforms of current in the A-phase and B-phase excitation coils connected to the constant current flop-flip circuit (current switching current) shown in FIG. 8 as well as charging voltage waveforms across a capacitor;

FIGS. 10A to 10C are views showing three different relative positions, respectively, of the set of the first rotor unit and the first stator unit as a representative of the four sets of the stator units and the rotor units when driving the switched reluctance motor;

FIG. 11 is a waveform diagram showing waveforms of constant DC rectangular-wave current flowing in the A-phase and B-phase excitation coils wound on each stator unit;

FIGS. 12A to 12C are views showing three different relative positions, respectively, of the set of the first rotor unit and the first stator unit as a representative of the four sets of the stator units and the rotor units when braking the switched reluctance motor;

FIG. 13 is a schematic view showing relationship between dimensions of each stator unit and the corresponding rotor unit as well as a magnetic circuit formed between in-phase magnetic poles of the first stator unit;

FIGS. 14A to 14D are schematic views, each showing a distribution of magnetic flux formed in an air gap between a salient pole of a rotor unit and a magnetic pole of the corresponding stator unit, at four different rotational angular positions when driving the switched reluctance motor;

FIG. 15 is a schematic diagram showing magnetic flux which is generated in an excited magnetic pole (A-phase), and which changes when the corresponding rotor unit rotates as shown in FIGS. 14A to 14D, and also showing electromotive force and torque generated based on the magnetic flux;

FIGS. 16A to 16D are schematic views, each showing a distribution of magnetic flux formed in the air gap between the salient pole of the rotor unit and the magnetic pole of the corresponding stator unit, at four different rotational angular positions when regeneratively braking the switched reluctance motor;

FIG. 17 is a schematic diagram showing magnetic flux which is generated in the excited magnetic pole (A-phase), and which changes when the corresponding rotor unit rotates as shown in FIGS. 16A to 16D, and also showing electromotive force and braking force generated based on the magnetic flux;

FIG. 18A is a schematic circuit diagram showing an equivalent circuit of the switched reluctance motor drive system in a state in which the switched reluctance motor is driven;

FIG. 18B is a schematic circuit diagram showing an equivalent circuit of the switched reluctance motor drive system in a state in which the switched reluctance motor is regeneratively braked;

FIG. 18C is a schematic circuit diagram showing an equivalent circuit of the switched reluctance motor drive system in a state in which the switched reluctance motor is stopped;

FIG. 19A is a schematic diagram of four charts (I) to (IV) showing time changes of torques of four phases (I) to (IV), each corresponding to one stator unit and one rotor unit, with magnetic pole reduction factor K=0.75, as well as a chart (S) showing a time change of synthesized torque of the torques of the four phases (I) to (IV);

Each of FIG. 19B, FIG. 19C and FIG. 19D is a schematic diagram of four charts (I) to (IV) and a chart (S) similar to those of FIG. 19A, respectively, except that the magnetic pole reduction factors K in FIG. 19B, FIG. 19C and FIG. 19D are K=0.5, K=0.8, and K=0.7, respectively; and

FIG. 20 is a schematic view showing a force (attractive force) exerted on each stator unit when the A-phase excitation coil is excited.

FIG. 21 is a schematic view showing one magnetic pole of one stator unit and one salient pole of one rotor unit for explaining effective power recovery to the DC constant current power supply unit.

### DETAILED DESCRIPTION OF THE INVENTION

Embodiments of the present invention, as best mode for carrying out the invention, will be described hereinafter with reference to the drawings. It is to be understood that the embodiments described herein are not intended as limiting, or encompassing the entire scope of, the present invention. Note that like parts are designated by like reference numerals, characters or symbols throughout the drawings.

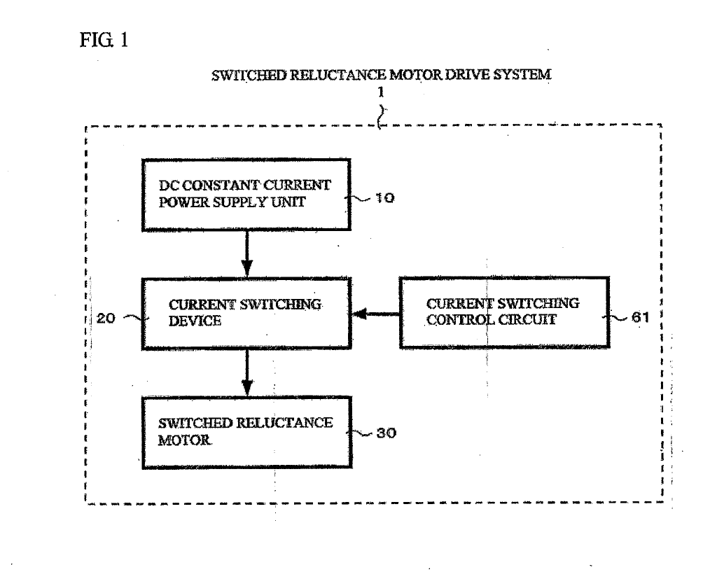

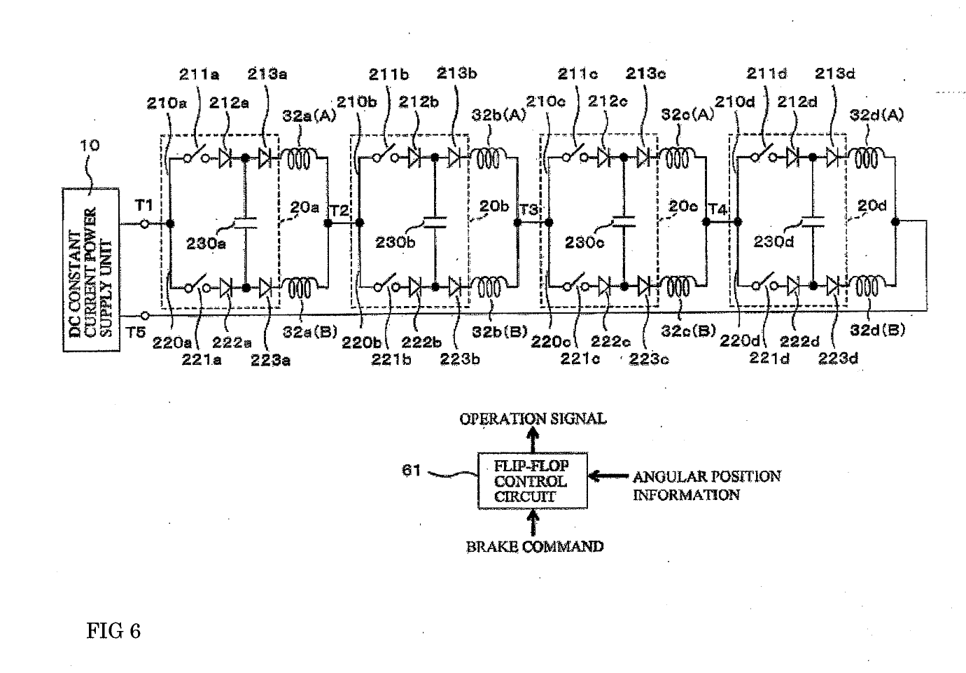

FIG. 1 is a schematic block diagram showing a basic structure of a switched reluctance motor drive system 1 according to an embodiment of the present invention. Referring to FIG. 1, the switched reluctance motor drive system 1 comprises a DC (direct current) constant current power supply unit 10, a current switching device 20, a switched reluctance motor 30, and a current switching control circuit (flip-flop control circuit) 61 (refer to FIG. 6). The DC constant current power supply unit 10 outputs a DC current having a value corresponding to a command from a control system (not shown). The current switching device 20 switches and alternately supplies a constant DC rectangular-wave current from the DC constant current power supply unit 10 to two systems of excitation coils (stator) as described later. The switched reluctance motor 30 is designed to allow a rotor fixed to a supporting shaft to rotate when the DC current is supplied as a rectangular-wave current to the two systems of excitation coils alternately at predetermined timings. The switched reluctance motor drive system 1 of the present embodiment will be described in detail below.

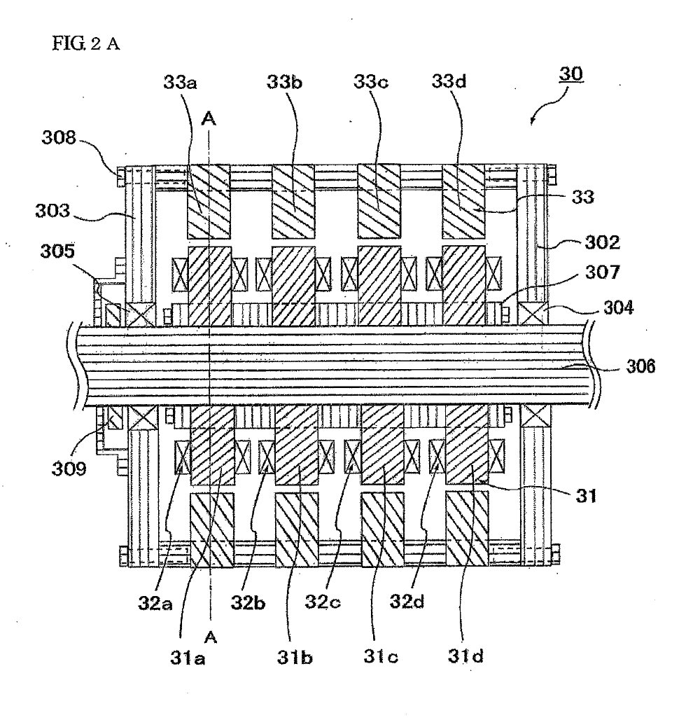

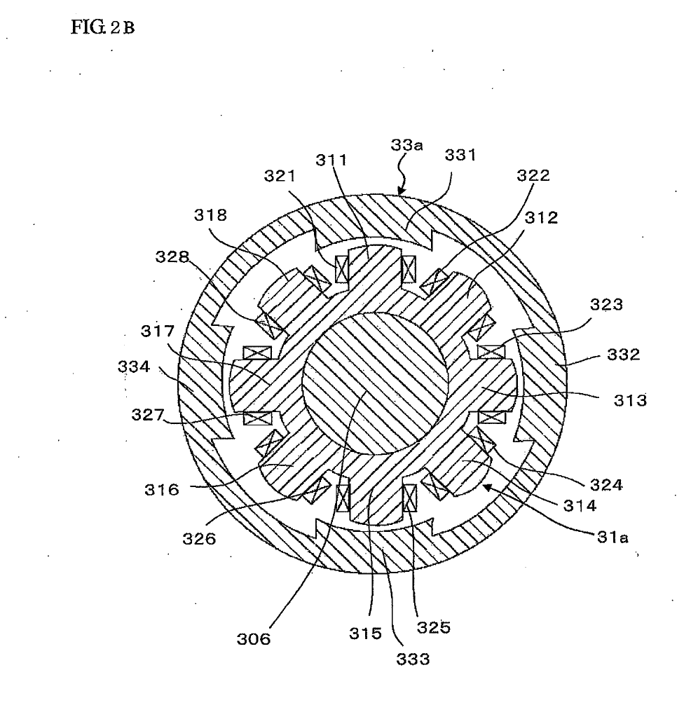

The switched reluctance motor 30 has a structure as shown in FIGS. 2A and 2B. FIG. 2A is a schematic axial cross-sectional view of the switched reluctance motor 30 along the axis of a supporting shaft 306, while FIG. 2B is a schematic cross-sectional view of the switched reluctance motor 30 along line A-A of FIG. 2A. Referring to FIGS. 2A and 2B, a pair of rotary plates 302, 303 have bearings 304, 305 fixed to central portions thereof, respectively, and are rotatably fixed to a supporting shaft 306 via the bearings 304, 305. A stator 31 is coaxial with and fixed to the supporting shaft 306 with a stator holder 307 of a non-magnetic material so as to rotate together with the supporting shaft 306. The stator 31 comprises a plurality (here four) of coaxially stacked stator units 31a, 31b, 31c, 31d each comprising an annular yoke formed of a laminated ferromagnetic steel plate and fit into the supporting shaft 306. The four stator units 31a, 31b, 31c, 31d are held at predetermined intervals by spacers of a non-magnetic material, and are coaxial with and fixed to the supporting shaft 306.

An annular rotor 33 coaxial with the supporting shaft 306 and having a circular outer core structure is arranged outside the stator 31 to surround the stator 31 and is fixed to the two rotary plates 302, 303 so as to be rotatable with the rotary plates 302, 303 around the supporting shaft 306 as an axis. The rotor 33 comprises a plurality (here four) of coaxially stacked rotor units 33a, 33b, 33c, 33c each of which comprises an annular yoke formed of a laminated ferromagnetic steel plate. The four stator units 31a, 31b, 31c, 31d correspond to the four rotor units 33a, 33b, 33c, 33d, respectively. The four rotor units 33a, 33b, 33c, 33c are held at predetermined intervals by spacers formed of a non-magnetic material so as to correspondingly face the stator units 31a, 31b, 31c, 31d, respectively, and are fixed to the rotary plates 302, 303 by fixing bolts 308. An angular position detector 309 is provided on a portion of the supporting shaft 306 which projects from the rotary plate 303. The angular position detector 309 detects a rotational angular position of the rotating rotary plate 303 (and hence of the rotor 33) and outputs a detection signal corresponding to the detected rotational angular position.

As representatively shown by the stator unit 31a in FIG. 2B, each of the four stator units 31a, 31b, 31c, 31d forming the stator 31 comprises eight (4n: n being an integer, here 2) magnetic poles 311, 312, 313, 314, 315, 316, 317, 318 which are arranged at equal angular intervals (predetermined angular intervals) from one another on an outer circumference of the annular yoke thereof. Excitation coils 321, 322, 323, 324, 325, 326, 327, 328 are wound on the magnetic poles 311 to 318, respectively. The four excitations coils 321, 323, 325, 327 wound on the magnetic poles 311, 313, 315, 317, each of which is every other one of the eight magnetic poles 311 to 318 of the stator unit 31a, are connected in series to form an A-phase excitation coil 32a(A) (claimed “first excitation coil”). Similarly, A-phase excitation coils (“first excitation coils”) 32b(A), 32c(A), 32d(A) of the stator units 31b, 31c, 31d are formed. On the other hand, the four excitations coils 322, 324, 326, 328 wound on the magnetic poles 312, 314, 316, 318, each of which is every other one of the remaining magnetic poles thereof (i.e. remaining four magnetic poles of the stator unit 31a), are also connected in series to form a B-phase excitation coil 32a(B) (claimed “second excitation coil”). Similarly, B-phase excitation coils (“second excitation coils”) 32b(B), 32c(B), 32d(B) of the stator units 31b, 31c, 31d are formed.

Each of the A-phase excitation coil 32a(A) and the B-phase excitation coil 32a(B) has input and output terminals. The winding direction of each of the excitation coils 32a(A), 32a(B) will be described later. It is to be noted that although the four excitation coils forming each of the A-phase and B-phase excitation coils 32a(A), 32a(B) have been described above as being connected in series, they can be connected in parallel if the A-phase excitation coil 32a(A) has the same electromagnetic properties as those of the B-phase excitation coil 32a(B) (which similarly applies to those 32b(A), 32b(B), those 32c(A), 32c(B), and those 32d(A), 32d(B)).

As described above, the switched reluctance motor 30 of the present embodiment has a structure that the number of stacks of the stator units 31a to 31d is four, while the number of magnetic poles of each of the stator units 31a to 31d of the stator 31 is eight. Thus, this structure will be referred to as an “8-4-pole 4-stack” structure. As representatively shown by the rotor unit 33a in FIG. 2B, each of the four rotor units 33a, 33b, 33c, 33d forming the rotor 33 comprises four (2n: n being an integer, here 2) salient poles (magnetic poles) 331, 332, 333, 334 which are arranged on an inner circumference of the annular yoke thereof at equal angular intervals (predetermined angular intervals) from one another, and the number of which is half the number of the magnetic poles 311 to 318 of each stator unit. The stator 31 is arranged relative to the rotor 33 such that a predetermined gap (air gap or magnetic gap) is formed between ends of the magnetic poles 311 to 318 of each of the stator units 31a to 31d and ends of the salient poles 331 to 334 of each of the corresponding rotor units 33a to 33d.

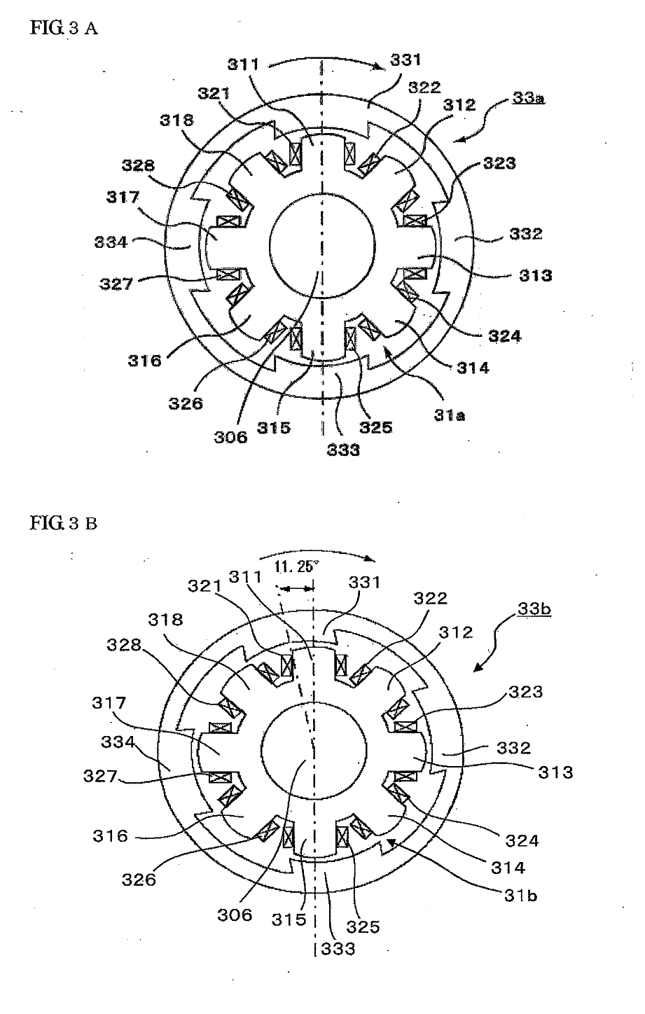

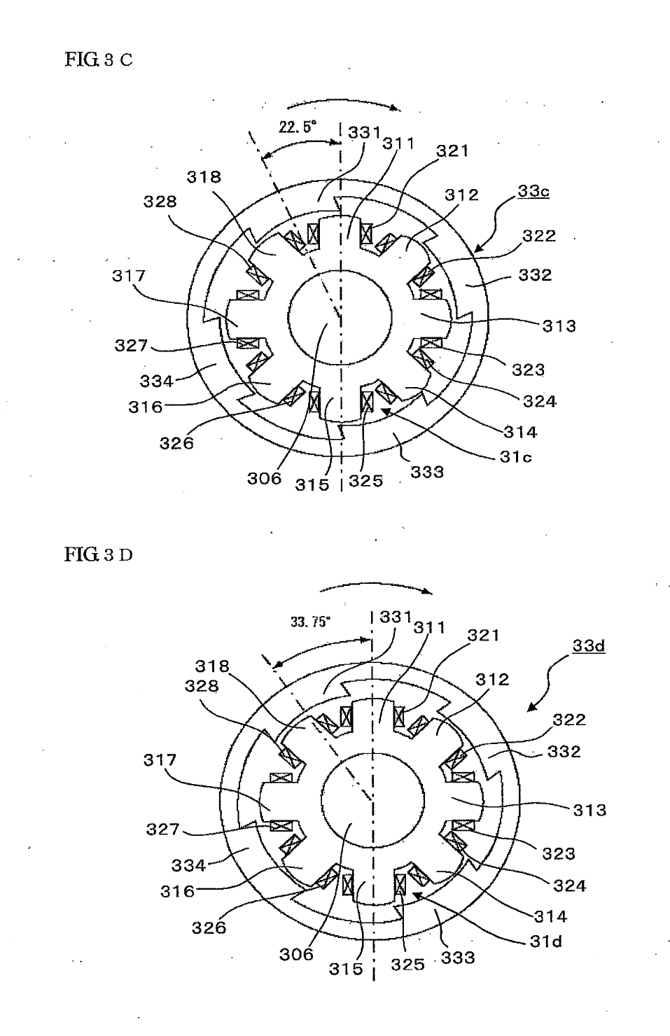

FIGS. 3A to 3D are schematic views showing an example of arrangement of four sets of the stator units and the corresponding rotor units, that are a set of the stator unit 31a with the rotor unit 33a, a set of the stator unit 31b with the rotor unit 33b, a set of the stator unit 31c with the rotor unit 33c, and a set of the stator unit 31c with the rotor unit 33d, respectively. In FIGS. 3A to 3D, the four stator units 31a to 31d are fixed to the supporting shaft 306 and aligned with one another along the supporting shaft 306 so as to be in the same angular position or relationship relative to the supporting shaft 306, while the four rotor units 33a to 33a are sequentially shifted one after another in angular position in the direction of rotation by a predetermined angle relative to the corresponding four stator units 31a to 31d. Here, the predetermined angle is a quotient of an angular pitch of 45° (electrical angle of 180°) of the magnetic poles of each of the plurality of stator units 31a to 31d divided by the number of the rotor units 33a to 33d (=4). This allows the multiple ones of the rotor units 33a to 33d to serve for one pitch of the magnetic poles of the stator units 31a to 31d in each of the rotor units 33a to 33d to sequentially receive an attractive force, allowing smoother rotation of the switched reluctance motor 30.

More specifically, referring to FIGS. 3A to 3D, when the rotor 33 is at a certain angular position (e.g. reference angular position), the rotor unit 33a (first rotor unit) is set at a position where the salient pole 331 is positioned facing the magnetic pole 311 of the stator unit 31a as shown in FIG. 3A, and the next (second) rotor unit 33b is set at a position shifted from the position shown in FIG. 3A in the opposite direction of rotation by an angle (=11.25°) equal to a quotient of an angular pitch of 45° (electrical angle of 180°) of the magnetic poles divided by the number of the salient poles 331, 332, 333, 334 (=4) as shown in FIG. 3B, i.e. by an angle) (=11.25°) equal to a quotient of an angular pitch of 45° (electrical angle of 180°) of the magnetic poles of each of the plurality of stator units 31a to 31d divided by the number of the rotor units 33a to 33d (=4).

On the other hand, the next (third) rotor unit 33c is set at a position shifted from the position shown in FIG. 3A in the opposite direction of rotation by an angle (=22.5°) equal to the double of the above angle) (=11.25°) as shown in FIG. 3C, and the next (fourth) rotor unit 33d is set at a position shifted from the position shown in FIG. 3A in the opposite direction of rotation by an angle (=33.75°) equal to the triple of the above angle (=11.25°) as shown in FIG. 3D. Thus, the four stator units 31a, 31b, 31c, 31d forming the stator 31 are angularly aligned with one another in the same angular position along the supporting shaft 306, while the four rotor units 33a, 33b, 33c, 33d forming the rotor 33 are arranged at angular positions which are sequentially shifted in the opposite direction of rotation by a predetermined angle (=11.25°) from the corresponding stator units 31a, 31b, 31c, 31d.

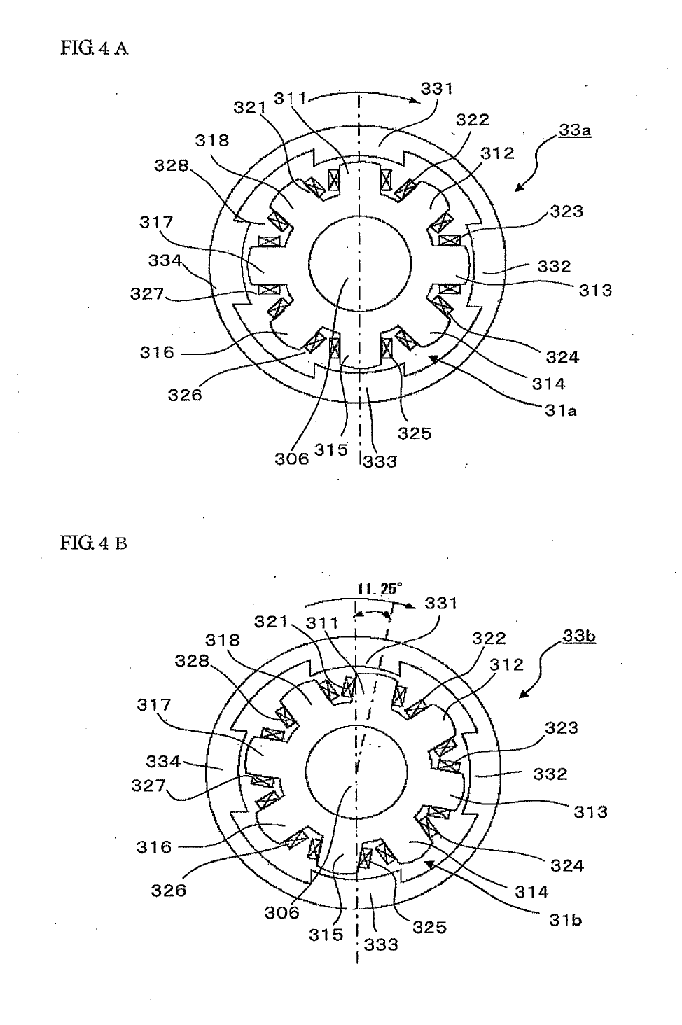

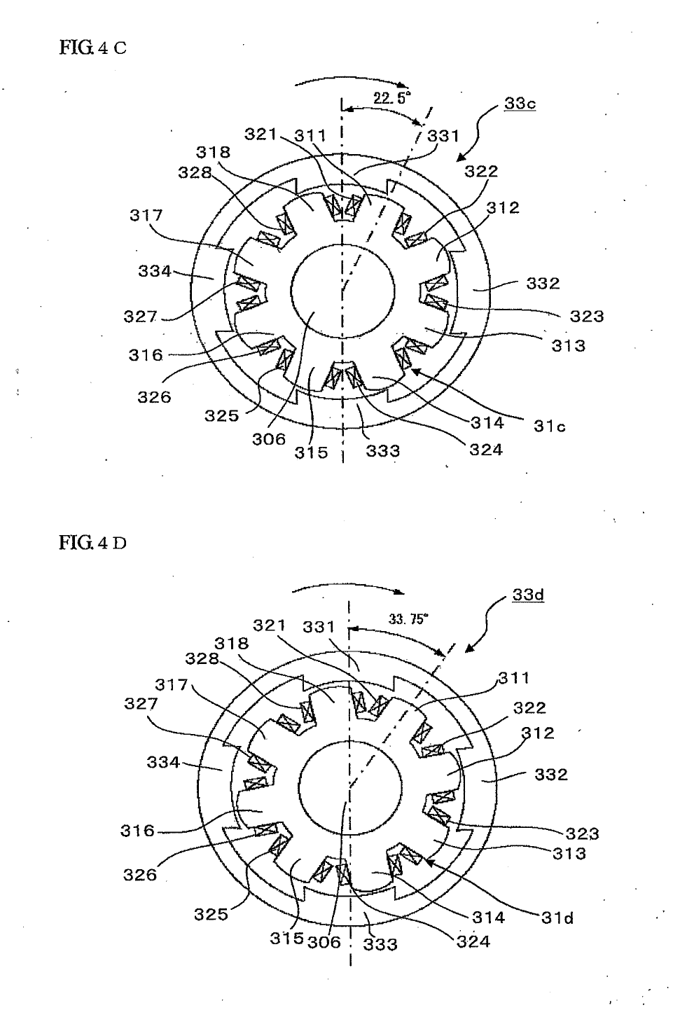

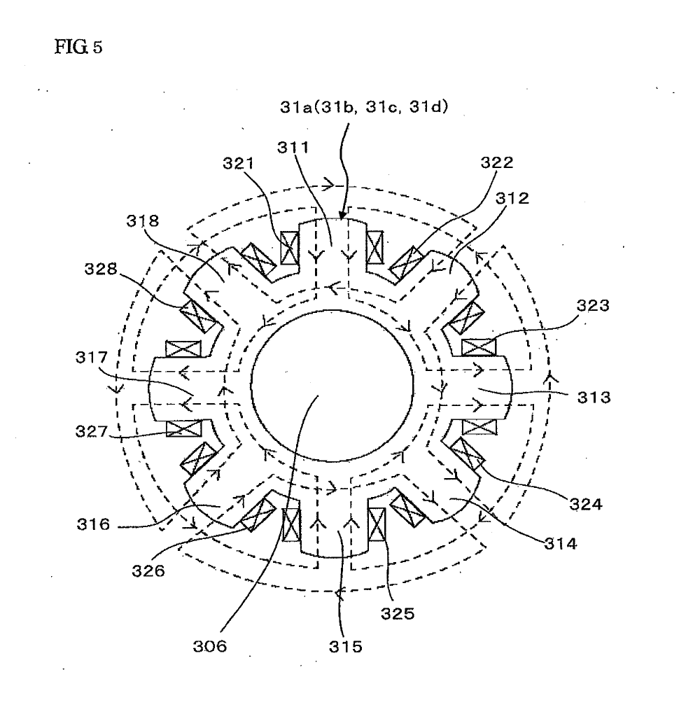

FIGS. 4A to 4D are schematic views showing another possible example of arrangement of four sets of the stator units 31a to 31d (first to fourth stator units) and the corresponding rotor units 33a to 33d (first to fourth rotor units) of the switched reluctance motor 30, respectively, similarly as in FIGS. 3A to 3D, except that in FIGS. 4A to 4D, the four rotor units 33a to 33d are aligned with one another in parallel to the supporting shaft 306 so as to be in the same angular position or relationship relative the supporting shaft 306, while the four stator units 31a to 31d are sequentially shifted one after another in angular position in the direction of rotation by a predetermined angle relative to the corresponding four rotor units 33a to 33d. More specifically, referring to FIGS. 4A to 4D, when the rotor 33 is at a certain angular position (e.g. reference angular position), the stator unit 31a (first stator unit) is set at a position where the magnetic pole 311 is positioned facing the salient pole 331 of the rotor unit 33a as shown in FIG. 4A, and the next (second) stator unit 31b is set at a position shifted from the position shown in FIG. 4A in the direction of rotation by an angle (=11.25°) equal to the quotient of an angular pitch of 45° (electrical angle of 180°) of the magnetic poles divided by the number of the salient poles (=4) as shown in FIG. 4B.

On the other hand, the next (third) stator unit 31c is set at a position shifted from the position shown in FIG. 4A in the direction of rotation by an angle (=22.5°) equal to the double of the above angle (=11.25°) as shown in FIG. 4C, and the next (fourth) stator unit 31d is set at a position shifted from the position shown in FIG. 4A in the direction of rotation by an angle (=33.75°) equal to the triple of the above angle (=11.25°) as shown in FIG. 4D. Thus, the rotor units 33a, 33b, 33c, 33d forming the rotor 33 are arranged to be angularly aligned with one another in the same angular position relative to the supporting shaft 306, while the four stator units 31a, 31b, 31c, 31d forming the stator 31 are arranged at angular positions which are sequentially shifted in the direction of rotation by a predetermined angle (=11.25°) from the corresponding rotor units 33a, 33b, 33c, 33d.

Next, FIG. 5 is a schematic view showing relationship between the A-phase and B-phase excitation coils wound on each of the stator units 31a to 31d as well as generated magnetic flux, in which the first stator unit 31a is shown as a representative. Referring to FIG. 5, the winding direction of the A-phase and B-phase excitation coils 32a(A), 32a(B) of the stator unit 31a (31b, 31c, 31d) wound on the eight magnetic poles 311 to 318 of the stator unit 31a (31b, 31c, 31d) in the present embodiment will be described. When a current (excitation current or excitation coil current) is allowed to flow from the input terminal to the output terminal of the A-phase excitation coil 32a(A) (32b(A), 32c(A), 32d(A)) wound on every other one of the magnetic poles 311 to 318 of the stator unit 31a (31b, 31c, 31d) that are the magnetic poles 311, 313, 315, 317, then, for example, a magnetic flux is generated to flow through the mutually facing magnetic poles 311, 315 from outside to inside, while at the same time a magnetic flux is generated to flow through the mutually facing magnetic poles 313, 317 from inside to outside, so as to form four magnetic circuits (refer to the dashed arrows in FIG. 5). The winding direction of the A-phase excitation coil 32a(A) (32b(A), 32c(A), 32d(A)) in the switched reluctance motor 30 is set to form such four magnetic circuits.

Similarly, when a current is allowed to flow from the input terminal to the output terminal of the B-phase excitation coil 32a(B) (32b(B), 32c(B), 32d(B)) wound on every other one of the magnetic poles 311 to 318 of the stator unit 31a (31b, 31c, 31d) that are the magnetic poles 312, 314, 316, 318, then, for example, a magnetic flux is generated to flow through the mutually facing magnetic poles 312, 316 from outside to inside, while at the same time a magnetic flux is generated to flow through the mutually facing magnetic poles 314, 318 from inside to outside, so as to form four magnetic circuits (refer to the dashed arrows in FIG. 5). The winding direction of the B-phase excitation coil 32a(B) (32b(B), 32c(B), 32d(B)) is set to form such four magnetic circuits. Thus, the switched reluctance motor 30 according to the present embodiment has a structure that four sets (four stacks) of excitation coils of two phases (A-phase and B-phase excitation coils) are provided on the four stator units 31a to 31d, respectively, as described above.

FIG. 6 is a schematic circuit diagram of an example of the current switching device 20. Referring to FIG. 6, the current switching device 20 comprises four constant current flip-flop circuits (current switching circuits) 20a, 20b, 20c, 20d (first to fourth flip-flop circuits) which are series-connected and are provided respectively corresponding to the four stator units 31a, 31b, 31c, 31d forming the stator 31 of the switched reluctance motor 30. The first constant current flip-flop circuit 20a corresponding to the stator unit 31a comprises: a first current path 210a comprising a first switching element 211a (semiconductor switch) and diodes 212a, 213a; and a second current path 220a comprising a second switching element 221a (semiconductor switch) and diodes 222a, 223a. The first current path 210a is connected in series with the A-phase excitation coil 32a(A) of the stator unit 31a, while the second current path 220a is connected in series with the B-phase excitation coil 32a(B) of the stator unit 31a. Further, a capacitor 230a as a circuit element for commutation to be described later is connected between a connection point of the two diodes 212a, 213a of the first current path 210a and a connection point of the two diodes 222a, 223a of the second current path 220a.

Like the first constant current flip-flop circuit 20a, the second constant current flip-flop circuit 20b corresponding to the stator unit 31b comprises: a first current path 210b comprising a first switching element 211b and diodes 212b, 213b; and a second current path 220b comprising a second switching element 221b and diodes 222b, 223b. The first and second current paths 210b, 220b are connected in series with the A-phase and B-phase excitation coils 32b(A), 32b(B) of the stator unit 31b, respectively. Likewise, the third constant current flip-flop circuit 20c corresponding to the stator unit 31c comprises: a first current path 210c comprising a first switching element 211c and diodes 212c, 213c; and a second current path 220c comprising a second switching element 221c and diodes 222c, 223c.

Likewise, the fourth constant current flip-flop circuit 20d corresponding to the stator unit 31d comprises: a first current path 210d comprising a first switching element 211d and diodes 212d, 213d; and a second current path 220d comprising a second switching element 221d and diodes 222d, 223d. The first and second current paths 210c, 220c are connected in series with the A-phase and B-phase excitation coil 32c(A), 32c(B) of the stator unit 31c, respectively, while the first and second current paths 210d, 220d are connected in series with the A-phase and B-phase excitation coils 32d(A), 32d(B) of the stator unit 31d, respectively. In the second (third, fourth) constant current flip-flop circuit 20b (20c, 20d) similarly as in the first constant current flip-flop circuit 20a, a capacitor 230b (230c, 230d) as a circuit element for commutation is connected between a connection point of the two diodes 212b, 213b (diodes 212c, 213c, diodes 212d, 213d) of the first current path 210b (210c, 210d) and a connection point of the two diodes 222b, 223b (diodes 222c, 223c, diodes 222d, 223d) of the second current path 220b (220c, 220d).

The first and second switching elements 211a, 221a of the first constant current flip-flop circuit 20a located at the first stage of the multi-stage constant flip-flop circuits 20a to 20d are connected to an output terminal T1 (one of the output terminals) of the DC constant current power supply unit 10. The A-phase and B-phase excitation coils 32a(A), 32a(B) of the stator unit 31a respectively connected to the first and second current paths 210a, 220a of the first constant current flip-flop circuit 20a are connected to the first and second switching elements 211b, 221b of the second constant current flip-flop circuit 20b located at the second stage via a connection point T2. The A-phase and B-phase excitation coils 32b(A), 32b(B) of the stator unit 31b respectively connected to the first and second current paths 210b, 220b of the second constant current flip-flop circuit 20b are connected to the first and second switching elements 211c, 221c of the third constant current flip-flop circuit 20c located at the third stage via a connection point T3.

The A-phase and B-phase excitation coils 32c(A), 32c(B) of the stator unit 31c respectively connected to the first and second current paths 210c, 220c of the third constant current flip-flop circuit 20c are connected to the first and second switching elements 211d, 221d of the fourth constant current flip-flop circuit 20d located at the final stage of the multi-stage the constant flip-flop circuits 20a to 30d via a connection point T4. Further, the A-phase and B-phase excitation coils 32d(A), 32d(B) of the stator unit 31d respectively connected to the first and second current paths 210d, 220d of the fourth constant current flip-flop circuit 20d are connected to an output terminal T5 (another one of the output terminals) of the DC constant current power supply unit 10.

The DC constant current power supply unit 10 is configured to output a constant DC current with a constant value corresponding to a set constant current value commanded by a current set command (from the output terminal T1) in a constant direction regardless of the polarity and magnitude of load electromotive force appearing across the current switching device 20. The DC constant power supply unit 10, the current switching device 20 and the switched reluctance motor 3 are connected so that the constant DC current output from the output terminal T1 is fed back to the output terminal T5 of the DC constant current power supply unit 10 after being input to pass through: the first constant current flip-flop circuit 20a; the A-phase excitation coil 32a(A) or the B-phase excitation coil 32a(B) of the stator unit 31a; the connection point T2; the second constant current flip-flop circuit 20b; the A-phase excitation coil 32b(A) or the B-phase excitation coil 32b(B) of the stator unit 31b; the connection point T3; the third constant current flip-flop circuit 20c; the A-phase excitation coil 32c(A) or the B-phase excitation coil 32c(B) of the stator unit 31c, the connection point T4; the fourth constant current flip-flop circuit 20d; and the A-phase excitation coil 32d(A) or the B-phase excitation coil 32d(B) of the stator unit 31d.

Referring to FIG. 6, the operation of the flip-flop control circuit (current switching control circuit) 61 as switch control means of the switched reluctance motor drive system 1 will be described. The flip-flop control circuit 61 alternately turns on/off the first and second current paths (210, 220) of each of the plurality of flip-flop circuits 20a, 20b, 20c, 20d (current switching circuits) according to the angular position of the rotor 33 of the switched reluctance motor 30 so as to allow a rectangular-wave current to alternately flow in the first and second excitation coils (32(A), 32(B)). More specifically, the flip-flop control circuit 61 of the switched reluctance motor drive system 1 outputs an operation signal for switching the first and second switching elements 211a, 221a of the first constant current flip-flop circuit 20a based on an angular position information which indicates an angular position of the rotor 33 (supporting shaft 306) relative to the stator unit 31a based on a detection signal from the angular position detector 309. Similarly, the flip-flop control circuit 61 outputs an operation signal for switching the first and second switching elements 211b, 221b of the second constant current flip-flop circuit 20b based on an angular position information which indicates an angular position of the rotor 33 relative to the stator unit 31b based on a detection signal from the angular position detector 309.

Similarly, the flip-flop control circuit 61 outputs an operation signal for switching the first and second switching elements 211c, 221c of the third constant current flip-flop circuit 20c based on an angular position information which indicates an angular position of the rotor 33 relative to the stator unit 31c based on a detection signal from the angular position detector 309. Similarly, the flip-flop control circuit 61 outputs an operation signal for switching the first and second switching elements 211d, 221d of the second constant current flip-flop circuit 20d based on an angular position information which indicates an angular position of the rotor 33 relative to the stator unit 31d based on a detection signal from the angular position detector 309.

Further, the flip-flop control circuit 61 controls each of the plurality of flip-flop circuits 20a, 20b, 20c, 20d (current switching means) so that when receiving an input brake command from another control system (not shown), the flip-flop control circuit 61 shifts the output timing of the operation signal from the corresponding output timing used when driving the switched reluctance motor 30 (i.e. shifts the timing of on/off operations) by a time during which the rotor 33 is rotated by an angle corresponding to an electrical angle of 180°. In other words, the flip-flop control circuit 61 controls each of the constant current flip-flop circuits (current switching circuits) 20a, 20b, 20c, 20d so as to shift timing of the on/off operations of the first and second current paths, between when driving the switched reluctance motor 30 and when braking the switched reluctance motor 30, by a time during which the rotor 33 is rotated by an angle corresponding to an electrical angle of 180°.

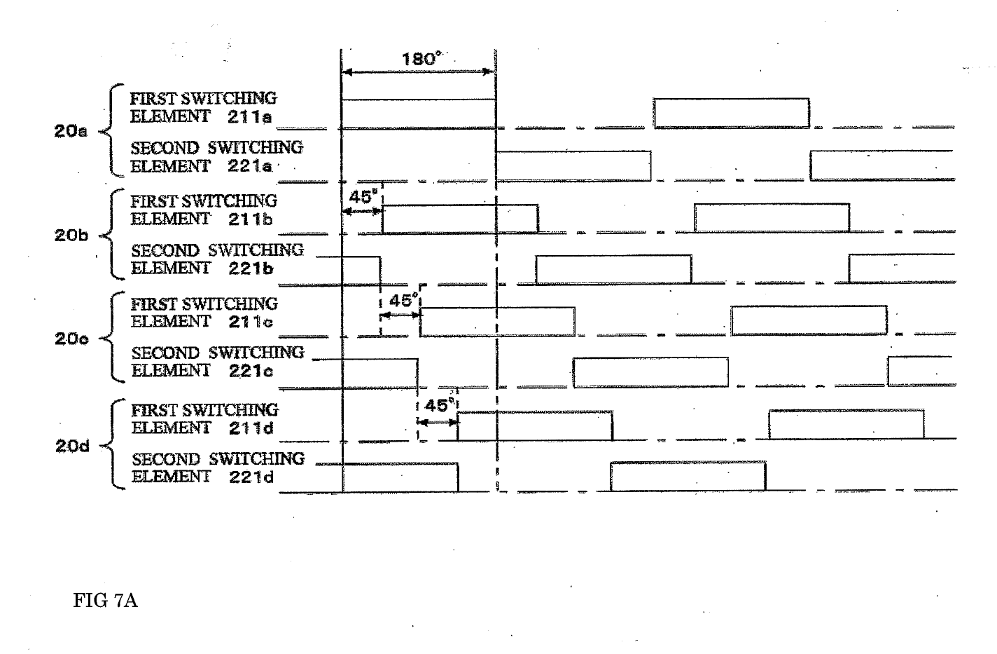

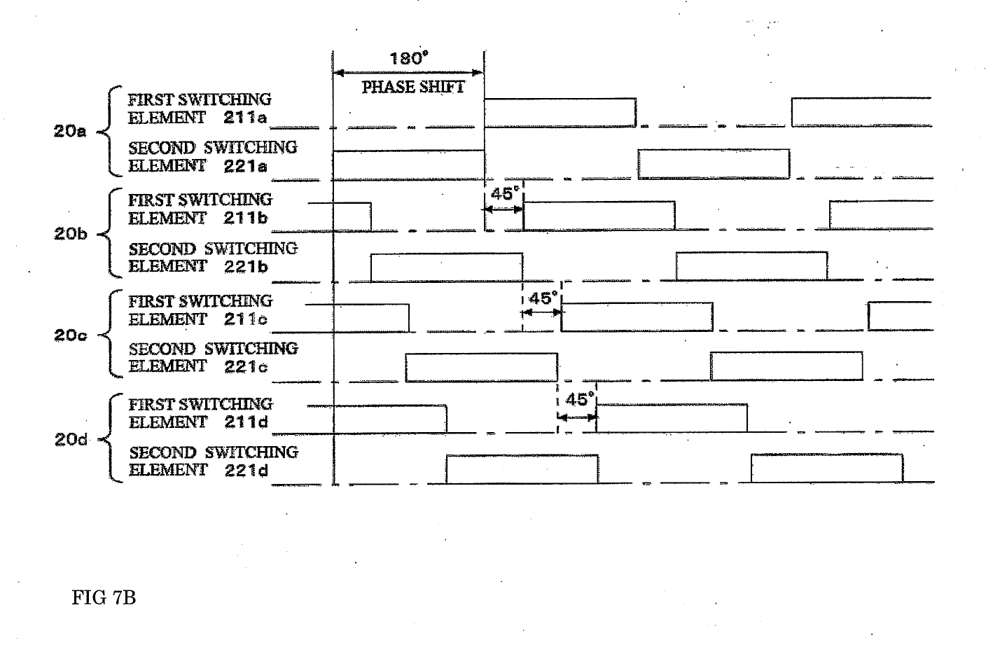

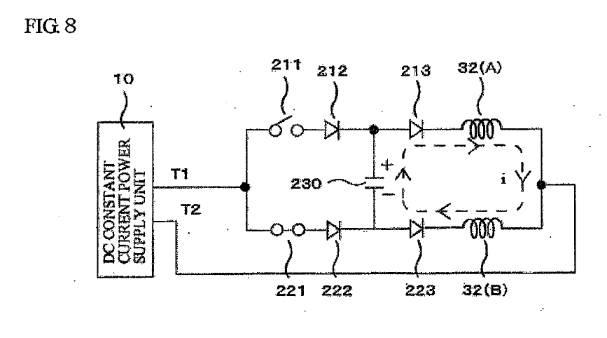

FIG. 7A is a timing chart showing an operation of the first switching elements 211a, 211b, 211c, 211d and the second switching elements 221a, 221b, 221c, 221d in the current switching device 20 when driving the switched reluctance motor 30, while FIG. 7B is a timing chart showing an operation of the first switching elements 211a, 211b, 211c, 211d and the second switching elements 221a, 221b, 221c, 221d in the current switching device 20 when braking the switched reluctance motor 30. As shown in FIG. 7A, when driving the switched reluctance motor 30, the flip-flop control circuit 61 (switch control means) controls the current switching device 20 to repeat on/off operations therein with a sequential phase difference of 180°/4=45° (electrical angle).

Here, the on/off operations are: on/off operation of the first and second switching elements 211a, 221a of the first constant current flip-flop circuit 20a; on/off operation of the first and second switching elements 211b, 221b of the second constant current flip-flop circuit 20b; on/off operation of the first and second switching elements 211c, 221c of the third constant current flip-flop circuit 20c; and on/off operation of the first and second switching elements 211d, 221d of the fourth constant current flip-flop circuit 20d. Thus, a constant DC rectangular-wave current is sequentially supplied, at predetermined timings (shifted timings), to the A-phase excitation coil (32(A)) and the B-phase excitation coil (32(B)) wound alternately on every other one of the eight magnetic poles (thus on the four magnetic poles) of each of the four stator units 31a to 31d forming the stator 31.

Similarly, as shown in FIG. 7B, when braking the switched reluctance motor 30, the flip-flop control circuit 61 (switch control means) controls the current switching device 20 to repeat the above-described on/off operations of the first switching elements 211a, 211b, 211c, 211d and the second switching elements 221a, 221b, 221c, 221d of the first to fourth constant current flip-flop circuits 20a, 20b, 20c, 20d with a sequential phase difference of 180°/4=45° (electrical angle). However, when braking the switched reluctance motor 30, the timing of each of these on/off operations is shifted by an electrical angle of 180° from the corresponding timing used when driving the switched reluctance motor 30.

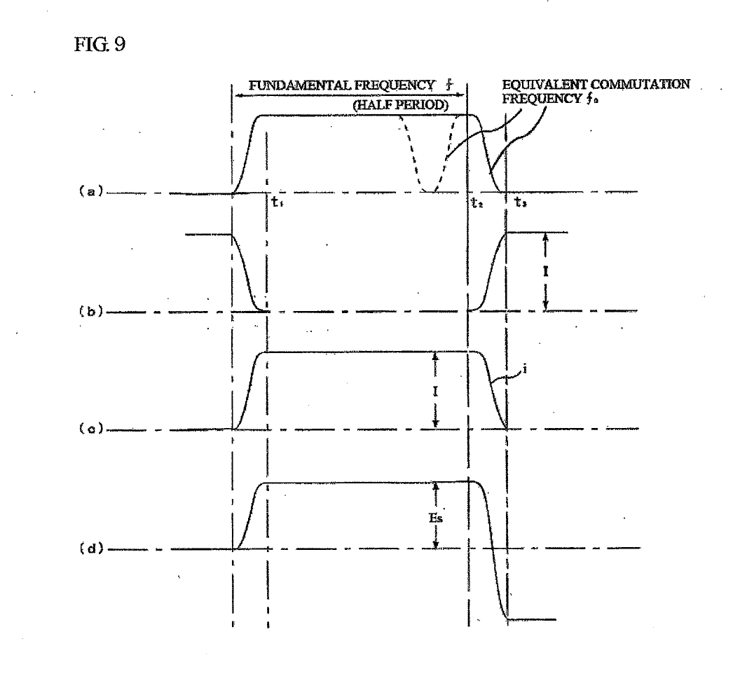

Referring now to FIG. 8 and FIG. 9, the commutation operation of each of the constant current flip-flop circuits 20a, 20b, 20c, 20d of the current switching device 20 in the switched reluctance motor drive system 1 will be described. FIG. 8 is a schematic simplified view showing the DC constant current power supply unit 10 and a constant current flip-flop circuit, forming a current switching device (current switching circuit), to which a constant DC current is supplied from the DC constant current power supply unit 10. FIG. 8 shows only one constant current flip-flop circuit since the commutation operation is the same for each of the constant current flip-flop circuits 20a, 20b, 20c, 20d, except that the timings of the respective commutation operations are shifted with a sequential phase difference of 180°/4=45° (electrical angle) as described above. That is, all the commutation operations of the respective constant current flip-flop circuits 20a, 20b, 20c, 20d as representatively shown by the one constant current flip-flop circuit in FIG. 8 are the same.

FIG. 9 is a waveform diagram showing waveforms of current in the A-phase and B-phase excitation coils 32(A), 32(B) connected to the corresponding constant current flop-flip circuit 20 and charging voltage waveforms across the capacitor 230. Waveform (a) of FIG. 9 is a current waveform in the A-phase excitation coil 32(A) during the period from when the current is turned on to when the current is turned off in the A-phase excitation coil 32(A), while waveform (b) of FIG. 9 is a current waveform in the B-phase excitation coil 32(B) during the period from when the current is turned off to when the current is next turned on in the B-phase excitation coil 32(B).

Waveform (c) of FIG. 9 is a waveform of circulating current i to circulate through the capacitor 230, the diode 213, the A-phase excitation coil 32(A), the B-phase excitation coil 32(B) and the diode 223 during the transition period of switching current, during which the current in the A-phase excitation coil 32(A) is turned off (i.e. trailing period) and the current in the B-phase excitation coil 32(B) is turned on (i.e. leading period). Note that the circulating current i is shown to flow backward through the diode 223. However, the circulating current i and a constant reverse current flowing through the diode 223 cancel each other, so that actually there is only a forward current in the diode 223. On the other hand, waveform (d) of FIG. 9 is a charging voltage waveform to charge the capacitor 230 by the circulating current i. As shown by the waveform (d) of FIG. 9, the polarity of the capacitor 230 is inverted after the end of the commutation period. The charging voltage of the capacitor 230 is maintained until the next commutation without being discharged through the diodes 212, 213, 222, 223.

As shown in FIG. 9, the on/off operations of the current flowing in the A-phase and B-phase excitation coils 32(A), 32(B) are periodically performed with fundamental frequency f (half period) of a rectangular wave, while the on/off operations during start-up and shut-down are performed with equivalent commutation frequency f₀ as shown by the solid curve and the complementary dashed curve in the waveform (a) of FIG. 9. The fundamental frequency f depends on the number P of poles of the excitation coil and the rotational speed N (per second), and is expressed by:

f=P/2×N (1)

The equivalent commutation frequency f₀ is a concept depending on the current switching speed of a constant current flip-flop (current switching circuit), and an appropriate value of the equivalent commutation frequency f₀ is selected from the range f<f₀ as described later.

The voltage generated across the capacitor 230 is calculated as an amount of reactance voltage drop of the A-phase excitation coil 32(A) from the value of the constant DC current as a peak value due to the sine wave current of the equivalent commutation frequency f₀, and thus can be expressed by:

Eₛ=2πf₀LI (2)

where Eₛ is capacitor voltage, L is reactance of the A-phase excitation coil 32(A) (B-phase excitation coil 32(B)), and I is constant DC current value. Note that although the reactance L is the sum of the reactance of the A-phase excitation coil 32(A) and that of the B-phase excitation coil 32(B), they virtually act as air core coils where the magnetic poles do not face the salient poles. Thus, it is sufficient to consider one magnetic pole facing one salient pole with an air gap of a given length.

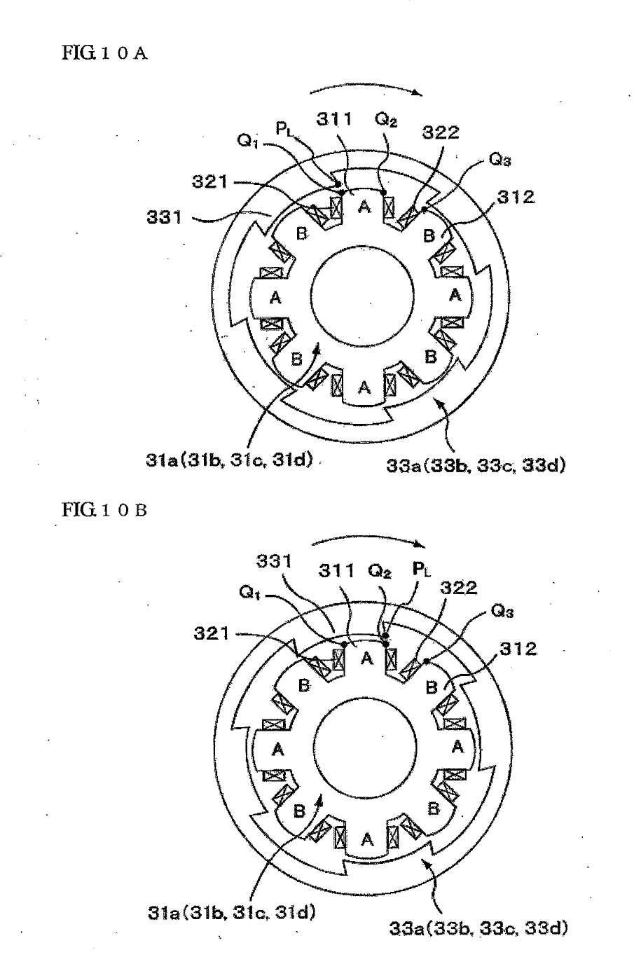

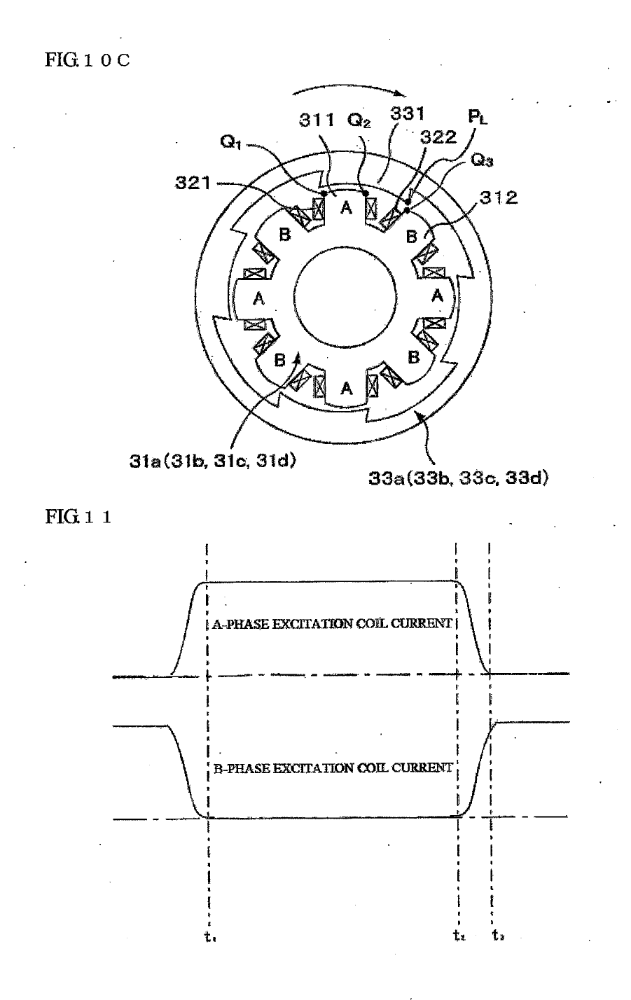

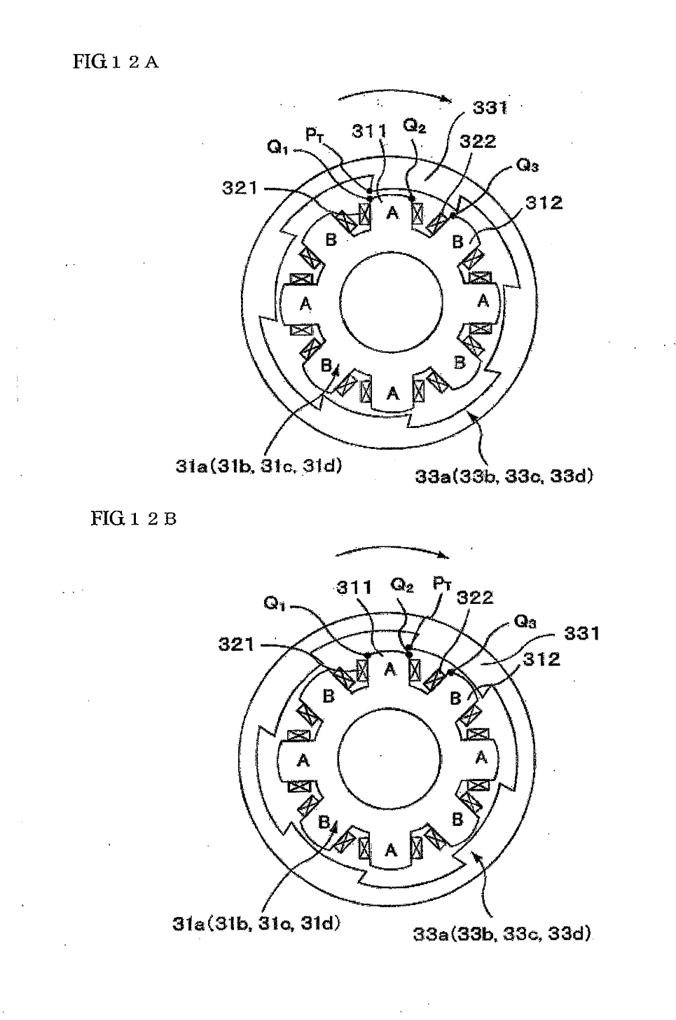

Referring now to FIGS. 10A to 10C and FIG. 11, the driving torque will be described, in which the clockwise (right) direction of rotation of the rotor 33 is taken as a reference direction. FIGS. 10A to 10C are views showing three different relative positions, respectively, of the set of the rotor unit 33a and the corresponding stator unit 31a as a representative of the four sets of the stator units 31a to 31d and the rotor units 33a to 33d when driving the switched reluctance motor 30. FIG. 10A shows a state where a point P_{L} at the downstream end (rotationally leading end) of the salient pole 331 of the rotor unit 33a is close to a point Q₁ at the upstream end of the magnetic pole 311 of the stator unit 31a, and FIG. 10B shows a state where the point P_{L} at the downstream end of the salient pole 331 is close to a point Q₂ at the downstream end of the magnetic pole 311, while FIG. 10C shows a state where the point P_{L} at the downstream end of the salient pole 331 is close to a point Q₃ at the upstream end of the next magnetic pole 312 of the stator unit 31a adjacent to the magnetic pole 311. The rotor unit 33a rotates in the sequence of FIGS. 10A to 10C by an angle corresponding to one pole pitch of the stator unit 31a from FIG. 10A to FIG. 10C due to the switching from the excitation of the magnetic pole 311 by the excitation coil 321 (A-phase excitation coil 32(A)) to the excitation of the next magnetic pole 312 by the excitation coil 322 (B-phase excitation coil 32(B)).

FIG. 11 is a waveform diagram showing waveforms of constant DC rectangular-wave current flowing in the A-phase and B-phase excitation coils 32(A), 32(B) wound on the stator unit 31a. A constant DC current flows alternately in the A-phase and B-phase excitation coils 32(A), 32(B) as shown in FIG. 11 by switching on and off the first and second switching elements 211, 221 of the constant current flip-flop circuit. More specifically, the on/off switching of the first and second switching elements 211, 221 of the constant current flip-flop circuit is controlled by the flip-flop control circuit 61 so that the excitation coil current is commutated to the A-phase excitation coil 32(A), and the commutation of the excitation coil current to the A-phase excitation coil 32(A) is completed where the point P_{L} at the downstream end of the salient pole 331 faces the point Q₁ at the upstream end of the magnetic pole 311 as shown in FIG. 10A (refer to time t₁ in FIG. 11).

The on/off switching of the first and second switching elements 211, 221 of the constant current flip-flop circuit is further controlled by the flip-flop control circuit 61 so that the commutation of the excitation coil current to the B-phase excitation coil 32(B) starts where the point P_{L} at the downstream end of the salient pole 331 faces the point Q₂ at the downstream end of the magnetic pole 311 as shown in FIG. 10B (refer to time t₂ in FIG. 11), and the commutation of the excitation coil current to the B-phase excitation coil 32(B) is completed where the point P_{L} at the downstream end of the salient pole 331 faces the point Q₃ at the upstream end of the next magnetic pole 312 as shown in FIG. 10C (refer to time t₃ in FIG. 11). Thus, during the period of transition from the state of FIG. 10A to the state of FIG. 10B, the salient pole 331 of the rotor unit 31a is attracted by an attractive force of the magnetic pole 311 excited by the excitation coil 321 (A-phase excitation coil 32(A)) so as to generate torque in the direction of rotation. Further, during the period of transition from the state of FIG. 10B to the state of FIG. 10C, the current in the excitation coil 321 (A-phase excitation coil 32(A)) decreases, and the current in the excitation coil 322 (B-phase excitation coil 32(B)) increases, making this transition period (from FIG. 10B to FIG. 10C) turn out to be a commutation period.

In the present embodiment, the width of each of the salient poles 331 to 334 of the rotor unit 33a in the direction of rotation is set to be larger than the width of each of the magnetic poles 311 to 318 of the stator unit 31a. This provides a mechanism to maintain, during this transition period (commutation period), the state in which the magnetic pole 311 faces the salient pole 331 over the entire width of the magnetic pole 311, thereby preventing resisting torque from being generated due to residual current in the A-phase excitation coil 32(A), and preventing the other salient poles (332 to 334) than the salient pole 331 from facing the B-phase excitation coil 32(B) (excitation coil 322) so that the attractive force due to the current during start-up in the B-phase excitation coil 32(B) (excitation coil 322) has no bad influence on the rotation of the rotor unit 33a. This width relationship of each salient pole and each magnetic pole reduces a period of time during which each salient pole is prevented from facing the magnetic poles of the corresponding stator unit, thereby reducing a period of time during which the attractive force exerted by each magnetic pole on the salient poles of the corresponding rotor unit is deceased, so that the torque ripple and vibration of the switched reluctance motor can be reduced.

Thus, during the period of transition from the state of FIG. 10A to the state of FIG. 10B, a set maximum current flows in the A-phase excitation coil 32(A) (excitation coil 321) to generate effective torque. The effective torque is also generated in the state in which the excitation current is switched to the B-phase excitation coil 32(B) (excitation coil 322). Torque and load electromotive force are generated during the period of movement of the point P_{L} of each of the salient poles 331 to 334 of the rotor unit 33a from the point Q₁ to the point Q₂ of the corresponding magnetic pole 311 within the period of the movement of the point P_{L} from the point Q₁ to the point Q₃. Here, a magnetic pole reduction factor K is defined by:

(Arc length from Q₁ to Q₂)/(Arc length from Q₁ to Q₃)=K (3)

Note that the values of the torque and the electromotive force of the entire switched reluctance motor 30 are respectively calculated by multiplying (i) the torque and the electromotive force obtained above for each salient pole, (ii) the total number 4 of the salient poles of each of the rotor units, and (iii) the total number 4 of stacks of the rotor units and stator units.

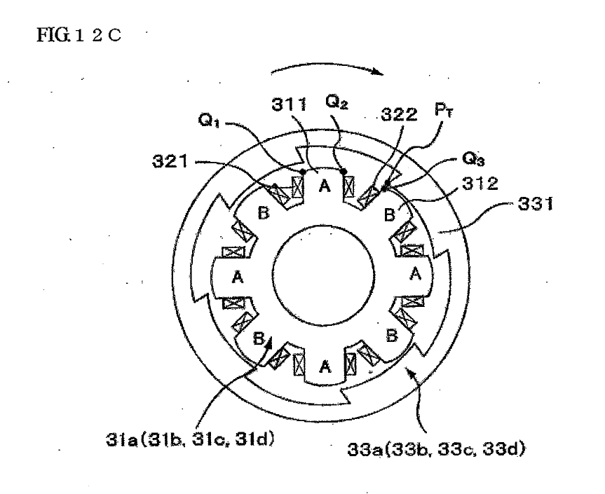

Referring now to FIGS. 12A to 12C, the regenerative braking torque will be described. FIGS. 12A to 12C are views showing three different relative positions, respectively, of the set of the rotor unit 33a and the stator unit 31a as a representative of the four sets of the stator units 31a to 31d and the rotor units 33a to 33d when braking the switched reluctance motor 30. FIG. 12A shows a state where a point P_{T} at the upstream end (rotationally trailing end) of the salient pole 331 of the rotor unit 33a is close to a point Q₁ at the upstream end of the magnetic pole 311 of the stator unit 31a, and FIG. 12B shows a state where the point P_{T} at the upstream end of the salient pole 331 is close to a point Q₂ at the downstream end of the magnetic pole 311, while FIG. 12C shows a state where the point P_{T} at the upstream end of the salient pole 331 is close to a point Q₃ at the upstream end of the next magnetic pole 312 of the stator unit 31a adjacent to the magnetic pole 311. Similarly as in FIGS. 10A to 10C, the rotor unit 33a rotates in the sequence of FIGS. 12A to 12C by an angle corresponding to one pole pitch of the stator unit 31a from FIG. 12A to FIG. 12C, except that the angular positions of the rotary unit 33a shown in FIGS. 12A to 12C are delayed from those shown in FIGS. 10A to 10C by an angle corresponding to the width of each salient pole, that is 360°/8=45° (mechanical angle) or 180° (electrical angle).

The on/off switching of the first and second switching elements 211, 221 of the constant current flip-flop circuit is controlled by the flip-flop control circuit 61 so that the excitation coil current is commutated to the A-phase excitation coil 32(A), and the commutation of the excitation coil current to the A-phase excitation coil 32(A) is completed where the point P_{T} at the upstream end of the salient pole 331 faces the point Q₁ at the upstream end of the magnetic pole 311 as shown in FIG. 12A (refer to time t₁ in FIG. 11), and that the commutation of the excitation coil current to the B-phase excitation coil 32(B) starts where the point P_{T} at the upstream end of the salient pole 331 faces the point Q₂ at the downstream end of the magnetic pole 311 as shown in FIG. 12B (refer to time t₂ in FIG. 11), and further that the commutation of the excitation coil current to the B-phase excitation coil 32(B) is completed where the point P_{T} at the upstream end of the salient pole 331 faces the point Q₃ at the upstream end of the next magnetic pole 312 as shown in FIG. 12C (refer to time t₃ in FIG. 11).

Thus, during the period of transition from the state of FIG. 12A to the state of FIG. 12B, the salient pole 331 of the rotor unit 31a is attracted by an attractive force of the magnetic pole 311 excited by the excitation coil 321 (A-phase excitation coil 32(A)) in the opposite direction of rotation so as to exert a regenerative braking force on the rotor unit 31a against rotation. Further, during the period of transition from the state of FIG. 12B to the state of FIG. 12C, the excitation current is commutated from the A-phase excitation coil 32(A) to the B-phase excitation coil 32(B). As described above, the width of each of the salient poles 331 to 334 of the rotor unit 31a in the direction of rotation is larger than the width of each of the magnetic poles 311 to 318 of the stator unit 33a (refer to the description of operation during the period of transition from the state of FIG. 10B to the state of FIG. 10C), which provides the same mechanism described above, so that the commutation of excitation current from the A-phase excitation coil 32(A) to the B-phase excitation coil 32(B) does not prevent or have any bad influence on the regenerative braking.

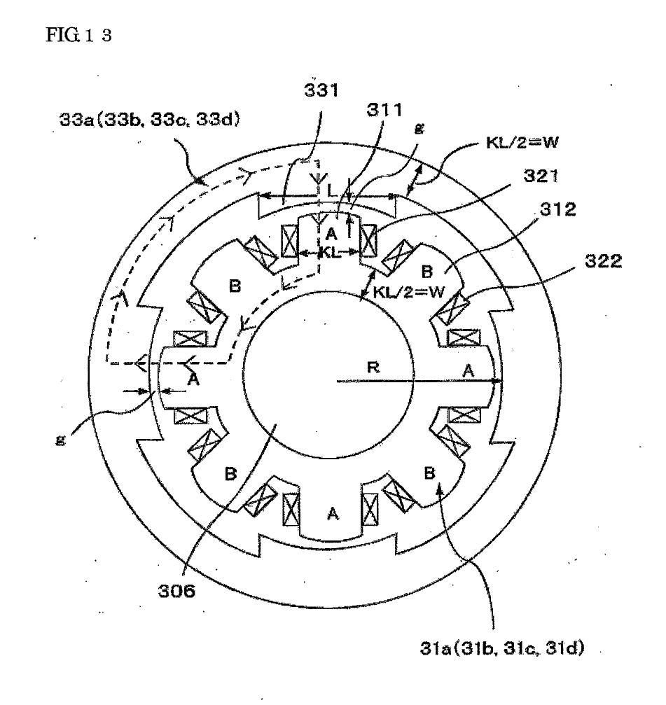

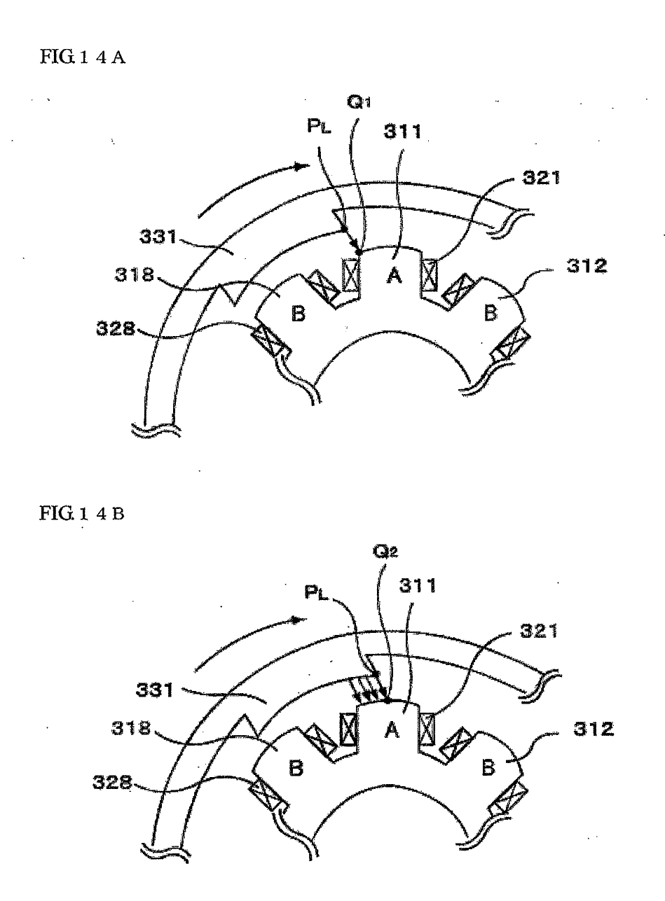

Next, FIG. 13 is a schematic view showing relationship between dimensions of each of the stator units 31a to 31d and the rotor units 33a to 33d, in which the stator unit 31a and the rotator unit 33a are shown as a representative, and also showing a magnetic circuit formed between the in-phase magnetic poles of the stator unit 31a. Referring to FIG. 13, the ampere-turn (magnetomotive force) of each of the excitation coils will be described. In the stator unit 31a, the magnetic poles (311, 313, 315, 317) having the excitation coils (321, 323, 325, 327) as the A-phase coil 32(A) wound thereon and the magnetic poles (312, 314, 316, 318) having the excitation coils (322, 324, 326, 328) as the B-phase coil 32(B) wound thereon are alternately arranged. As shown in FIG. 5, eight magnetic circuits are formed between the in-phase magnetic poles. FIG. 13 shows one of the eight magnetic circuits by the dashed arrow. Each of the magnetic circuits includes two excitation coils and two air gaps g.

Now let us consider the magnetic flux density of the core of the stator unit. If the magnetic flux density is below the saturation level, the magnetic resistance of the core can be neglected compared to the magnetic resistance of the air gap g, so that the ampere-turn of one excitation coil can be considered to correspond to one air gap g. Based on the general theory of electromagnetism, the ampere-turn (IN) can be expressed by the equation:

I·N(AT)=B·g/μ₀≈B·g×800,000 (4)

In the equation, I, N, B, g and μ₀ denote:

I: Excitation coil current (A)

N: Number of turns of the excitation coil

B: Air gap magnetic flux density (T)

g: Air gap length (m)

μ₀: Permeability of free space

In a normal core (silicon steel), the value of the maximum magnetic flux density below the saturation level is considered to be about 1.6 T. This value can be used as a rough reference value to design the excitation coils when an emphasis is placed on small size and light weight of the switched reluctance motor 30. Note that in the case of a small capacity motor, the value of the air gap magnetic flux density B can be designed to be lower than this reference value.

Referring to FIG. 13, the width of the magnetic pole, the width of the salient pole and the width of the yoke of the stator will be described. The width (arc length) L of the salient pole 331 (332, 333, 334) of the rotor unit 33a (33b, 33c, 33d) is set using the following equation as a reference:

L=2πR/8 (number of magnetic poles) (5)

where R is radius (m) at the outer end of the salient pole 331 (332, 333, 334) of the rotor unit 33a (33b, 33c, 33d). On the other hand, the width (arc length) L′ of the magnetic pole 311 (312 to 318) of the stator unit 31a (31b, 31c, 31d) is set using the following equation as a reference:

L′=K·L (6)

where K is magnetic pole reduction factor according to the above equation (3), and is selected from K<1 as a reference. The magnetic pole reduction factor K has an important relationship with the torque ripple and space for the excitation coil as described later. The width W of the yoke of the stator unit 31a (31b, 31c, 31d) (thickness of the cylindrical part of the stator unit) can be set according to the following equation:

W=L′/2 (7)

This is because the magnetic flux passing through the magnetic pole is divided into the two halves (left and right).

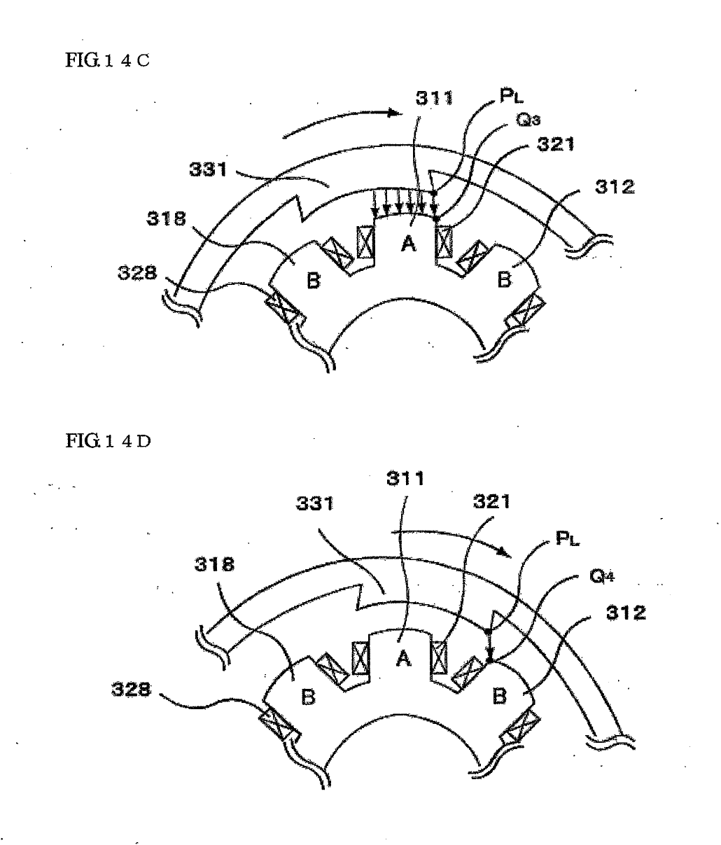

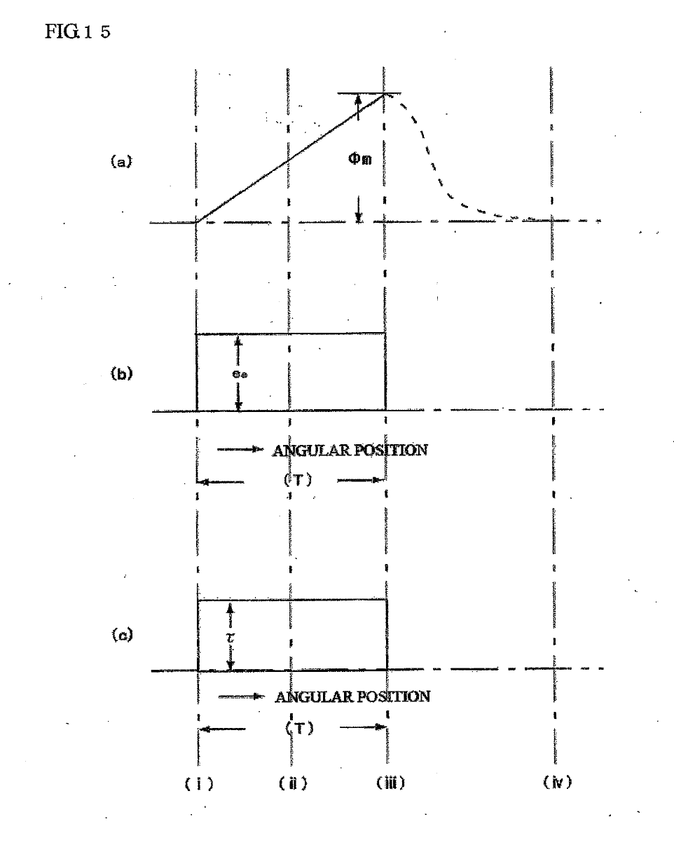

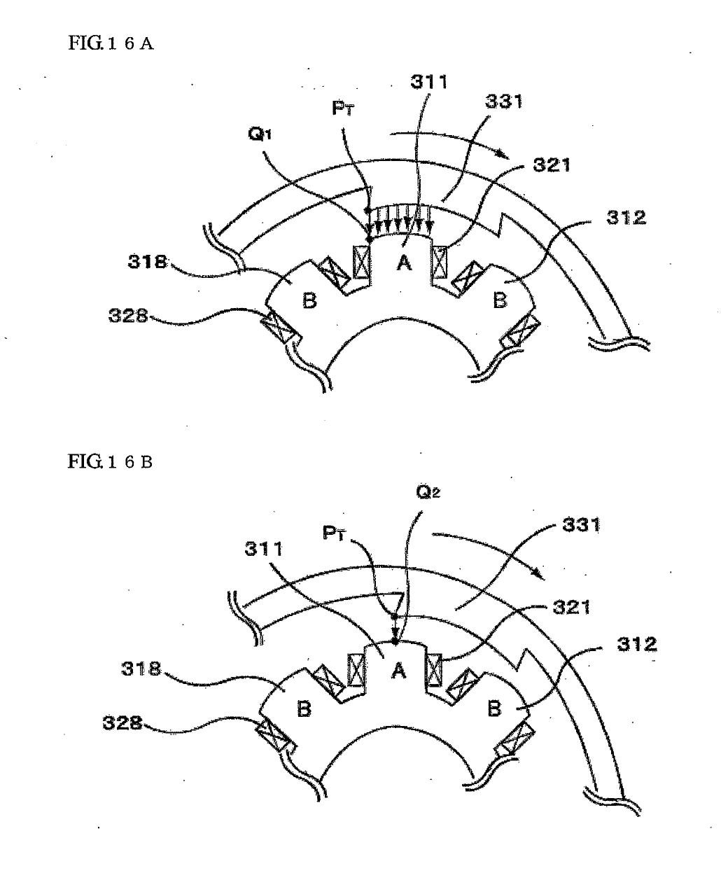

Referring now to FIGS. 14A to 14D and FIG. 15, the electromotive force induced in the excitation coils when driving the switched reluctance motor 30 will be described. Each of FIGS. 14A to 14D is a schematic view of the salient pole 331 (332, 333, 334) of the rotor unit (33a, 33b, 33c, 33d) and the magnetic pole 311 (A-phase) and the adjacent magnetic poles 318, 312 (B-phase) of the stator unit (31a, 31b, 31c, 31d) when driving the switched reluctance motor 30, showing a distribution of magnetic flux formed in the air gap between the salient pole 331 of the rotor unit and the magnetic pole 311 of the stator unit at a rotational angular position.

More specifically, FIG. 14A shows a moment (angular position (i) or time (i) of FIG. 15) when a point P_{L} at the downstream end (rotationally leading end) of the salient pole 331 of the rotor unit gets close to a point Q₁ at the upstream end of the magnetic pole 311 of the stator unit. FIG. 14B shows a moment (angular position (ii) or time (ii) of FIG. 15) when the point P_{L} gets close to an approximate center point Q₂ of the magnetic pole 311. FIG. 14C shows a moment (angular position (iii) or time (iii) of FIG. 15) when the point P_{L} gets close to a point Q₃ at the downstream end of the magnetic pole 311. FIG. 14D shows a moment (angular position (iv) or time (iv) of FIG. 15) when the point P_{L} gets close to a point Q₄ at the upstream end of the adjacent magnetic pole 312. The arrows in the air gap in each of FIGS. 14A to 14D indicate the magnetic flux generated in the air gap. Assuming no magnetic flux leakage to simplify the discussion, the air gap magnetic flux density in the area where the salient pole 331 of the rotor unit faces the magnetic pole 311 of the stator unit has a value according to the above equation (4). On the other hand, in the area where the salient pole 331 does not face the magnetic pole 311, the air gap length is infinite so that the air gap magnetic flux density is 0 (zero).

FIG. 15 is a schematic diagram showing magnetic flux which is generated in the excited magnetic pole, and which changes with time as the rotor unit (33a, 33b, 33c, 33d) rotates as shown in FIGS. 14A to 14D, and also showing electromotive force and torque generated based on the magnetic flux. Sloped and partially dashed curve (a) of FIG. 15 is a curve showing change of the magnetic flux generated in the excited magnetic pole 311 in the states of FIGS. 14A to 14D, in which the horizontal axis is the rotational angular position, while angular positions (i) to (iv) correspond to the angular positions shown in FIGS. 14A to 14D, respectively. When the rotor 33 rotates at a constant angular velocity, the horizontal axis of FIG. 15 can be regarded to be the same in concept as a time axis, so that the angular positions (i) to (iv) can be regarded as times (i) to (iv), respectively. Thus, the magnetic flux in the excited magnetic pole increases linearly in the process from time (i), as a starting point, to time (ii) and to time (iii) to reach its maximum magnetic flux Φₘ which can be expressed by:

Φₘ=B·L′a (Weber) (8)

where B is the magnetic flux density (T) calculated by the above equation (4), and a is thickness (m) of the magnetic pole.

When the magnetic flux passing through the excited magnetic pole changes with time, an electromotive force eₐ is generated in the corresponding excitation coil according to Faraday's law. Rectangular curve (b) of FIG. 15 is a curve showing the generated electromotive force eₐ. The electromotive force eₐ is calculated by the following equation (9):

eₐ=N·dΦ/dt=N·dΦₘ/T (9)

where N is number of turns of the excitation coil, T is transition period (seconds) between the moment shown in FIG. 14A to the moment shown in FIG. 14C (namely between time (i) and time (iii)). The polarity of the electromotive force is in the direction which opposes the increase in the magnetic flux, that is, the polarity is positive at the entrance of the excitation coil.

As apparent from FIGS. 14A to 14D, the salient pole 331 of the rotor unit is attracted by the magnetic pole 311 of the stator unit to generate a clockwise driving torque. The electromotive force eₐ and the excitation current I are constant during the transition period T, that is, the power supply is constant during the transition period T, so that the generated torque is also constant during the transition period T. Rectangular curve (c) of FIG. 15 shows the torque τ. Assuming (power supply)=(mechanical torque output), the following equation (10) holds:

eₐ×I×T(J)=2πNτT(J) (10)

where N is rotational speed per second, and is τ torque (−N·m). The following equation (11) of torque τ can be deduced from equation (10):

τ=eₐ·I/2πN(−N·m) (11)

Thus, an average electromotive force eₐ′ and an average torque τ′ per one salient pole (salient pole 331), considering the magnetic pole reduction factor K, can be calculated according to the following equations (12), (13):

eₐ′=Keₐ (12)

τ′=Kτ (13)

In FIG. 15, the period between time (iii) and time (iv) is a period during which the A-phase excitation coil current is commutated to the B-phase excitation coil current. The A-phase excitation coil current decays. However, since the width of the magnetic pole of the stator unit is smaller than the width of the salient pole of the rotor unit, no torque is generated in either direction due to the attractive force. Further, during the commutation period, the electromotive force is separated from the circuit of the switched reluctance motor drive system 1, so that no electrical energy is supplied to and from such circuit. In addition, during the commutation period, no salient pole faces a magnetic pole with the B-phase excitation coil, so that no magnetomotive force is generated therebetween. At time (iv) in FIG. 15, the commutation of the excitation coil current from the A-phase excitation coil to the B-phase excitation coil is completed to start an operation based mainly on the magnetic poles with the B-phase excitation coil.

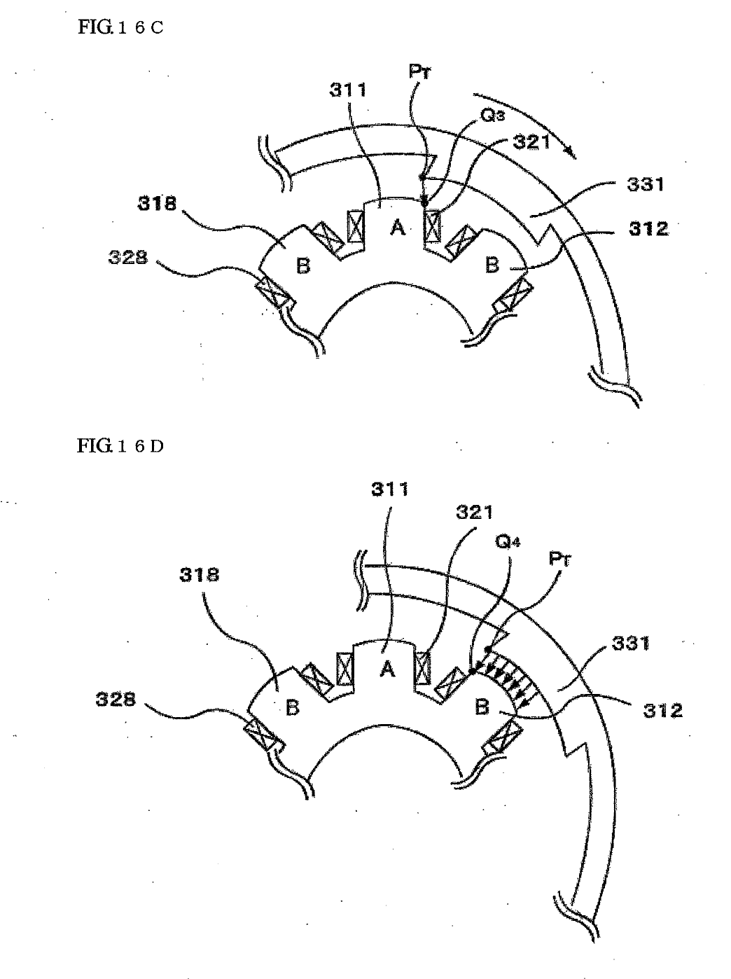

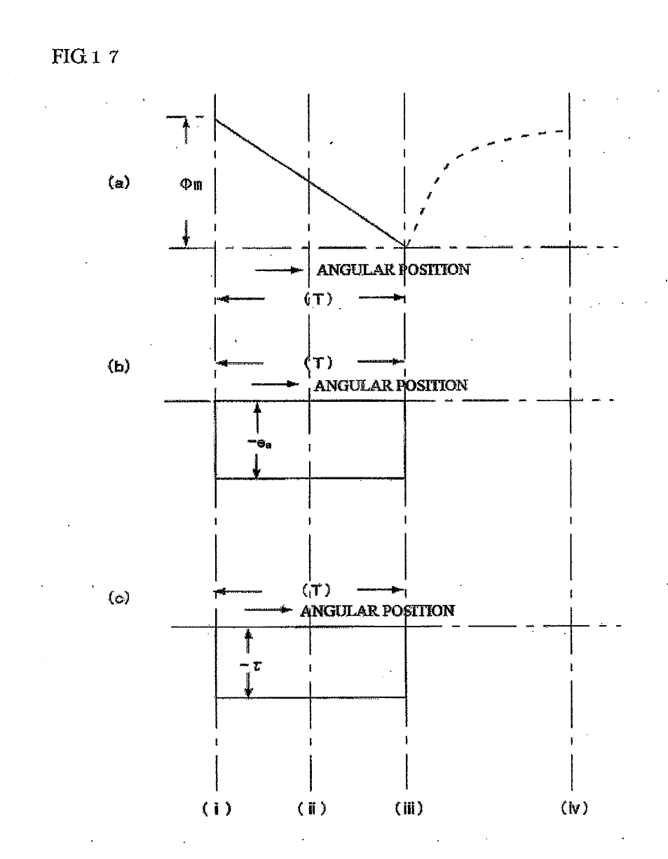

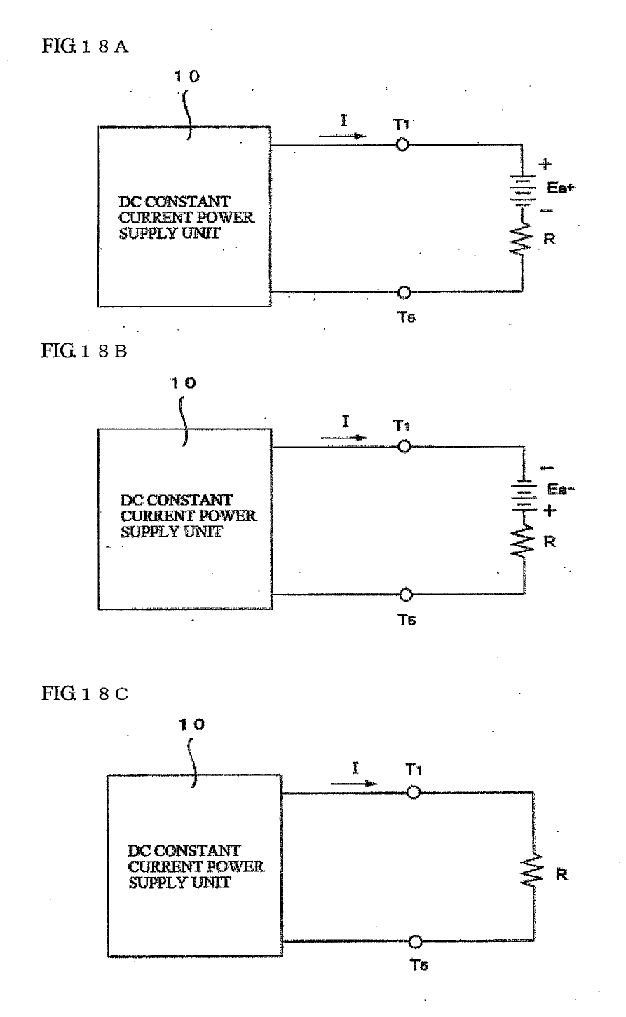

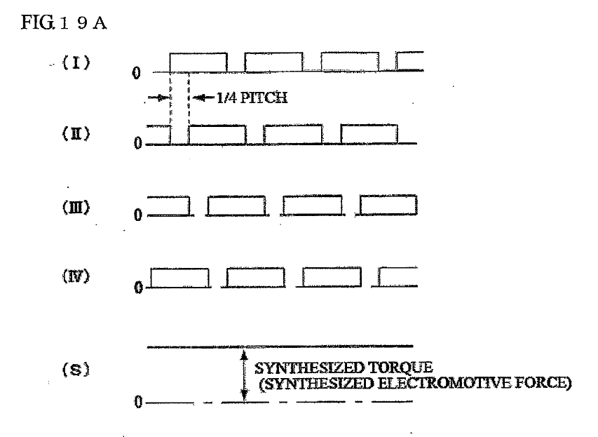

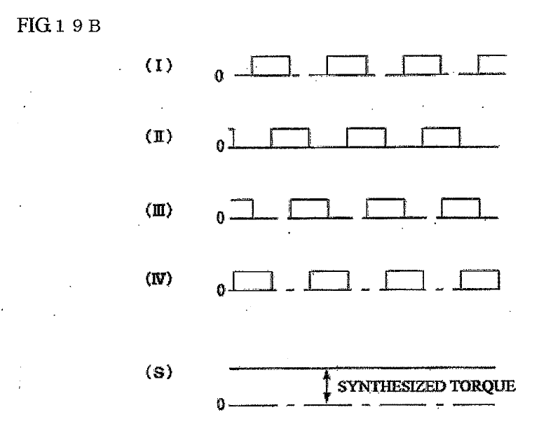

Referring now to FIGS. 16A to 16D and FIG. 17, the electromotive force of each of the excitation coils (321 to 328) when regeneratively braking the switched reluctance motor 30 will be described. Each of FIGS. 16A to 16D is a schematic view of the salient pole 331 (332, 333, 334) of the rotor unit (33a, 33b, 33c, 33d) and the magnetic pole 311 (A-phase) and the adjacent magnetic poles 318, 312 (B-phase) of the stator unit (31a, 31b, 31c, 31d) when regeneratively braking the switched reluctance motor 30. Each of FIGS. 16A to 16D shows, by the arrows, a distribution of magnetic flux formed in the air gap between the salient pole 331 of the rotor unit and the magnetic pole 311 of the stator unit at a rotational angular position. The showings of FIGS. 16A to 16D are similar to those of FIGS. 14A to 14D, respectively, except for the following.

FIGS. 14A to 14D show positions of the point P_{L} at the downstream end (rotationally leading end) of the salient pole 331 of the rotor unit relative to the respective points Q₁, Q₂, Q₃, Q₄ of the magnetic pole 311 of the stator unit, whereas FIGS. 16A to 16D show positions of a point P_{T} at an upstream end (rotationally trailing end) of the salient pole 331 relative to the respective points Q₁, Q₂, Q₃, Q₄ of the magnetic pole 311. More specifically, FIGS. 16A to 16D show states (phases or positions) which are respectively delayed from those of FIGS. 14A to 14D in the direction of rotation by an angle corresponding to the width or arc length (electrical angle of 180°) of the salient pole 331.

FIG. 17 is a schematic diagram showing magnetic flux which is generated in the excited magnetic pole 311, and which changes when the rotor unit (33a, 33b, 33c, 33d) rotates as shown in FIGS. 16A to 16D, and also showing electromotive force and braking force generated based on the magnetic flux. Similarly as in FIG. 15, sloped and partially dashed curve (a) of FIG. 17 shows change of the magnetic flux generated in the excited magnetic pole 311 in the states of FIGS. 16A to 16D (maximum magnetic flux Φₘ at the moment of FIG. 16A, and rectangular curve (b) of FIG. 17 shows the electromotive force (−eₐ) in the excitation coil while rectangular curve (c) of FIG. 17 shows braking force (−τ) generated in the salient pole 331 of the rotor unit. The value of the electromotive force is the same as that of the above equation (9), while the polarity of the electromotive force is in the direction which opposes the decrease in the magnetic flux, that is, the polarity is negative at the entrance of the excitation coil. The value of the braking force is the same as the driving torque of the above equation (11).

As described above with reference to FIGS. 2A, 2B, the switched reluctance motor 30 according to the present embodiment has an 8-4-pole 4-stack structure. Since the values of the average electromotive force eₐ′ and the average torque τ′ described above are of one salient pole, the corresponding values of one rotor unit are 4 times eₐ′ and τ′, and further the corresponding values of the entire switched reluctance motor 30 are 16 times eₐ′ and τ′, respectively. Thus, the output and torque of the entire switched reluctance motor 30 are:

Output=16·eₐ·I·K (14)

Torque=16(eₐ·I/2πN)·K (=Output/2πN) (15)

Referring now to FIGS. 18A to 18C, the electromotive force (speed electromotive force) as well as the supply and regeneration of electrical energy in the switched reluctance motor drive system 1 according to the present embodiment will be described. FIGS. 18A to 18C show the operation of the energy supply and regeneration in the DC constant current power supply unit 10 in response to the electromotive force (speed electromotive force) induced or generated by the rotation of the rotor 33. FIG. 18A is a schematic circuit diagram showing an equivalent circuit of the switched reluctance motor drive system 1 (current switching device 20) with electromotive force Ea (Ea⁺), resistance R and constant DC current I in a state in which the switched reluctance motor 30 is driven. FIG. 18B is a schematic circuit diagram showing an equivalent circuit of the switched reluctance motor drive system 1 (current switching device 20) with electromotive force Ea (Ea⁻), resistance R and constant DC current I in a state in which the switched reluctance motor 30 is regeneratively braked. On the other hand, FIG. 18C is a schematic circuit diagram showing an equivalent circuit of the switched reluctance motor drive system 1 (current switching device 20) with resistance R and constant DC current I in a state in which the switched reluctance motor 30 is stopped.

In the switched reluctance motor drive system 1 (current switching device 20), the product (Watt) of the electromotive force Ea calculated according to Faraday's law or Fleming's law and the current (Ampere) then flowing can be regarded as net power conversion or reversible power conversion. The constant DC current output from the output terminal T1 of the DC constant current power supply unit 10 is fed back to the output terminal T5 thereof through the A-phase excitation coil 32(A) or the B-phase excitation coil 32(B). In the state in which the switched reluctance motor 30 is driven, the positive electromotive force Ea is generated in the switched reluctance motor 30 as shown in FIG. 18A so that due to the power (Watt) of Ea⁺×I and the current I flowing in the A-phase excitation coil 32(A) or B-phase excitation coil 32(B) of resistance R, the power (Watt) of I²×R is supplied from the DC constant current power supply unit 10. Here, the power (Watt) of Ea⁺×I is a mechanical output, while the power (Watt) of I²×R is a loss.

In the state in which the switched reluctance motor 30 is braked, the negative electromotive force Ea⁻ is generated in the switched reluctance motor 30 as shown in FIG. 18B, and the mechanical power is converted to the power (Watt) of Ea⁻×I and the power the power (Watt) of I²×R. This power of Ea⁻×I is recovered and returned to the DC constant current power supply unit 10 (regeneration), while the power of I²×R is lost. In other words, when braking the switched reluctance motor 30, it is possible to feed back, to the DC constant current power supply unit 10, a current which is superimposed on the constant DC current supplied to the A-phase excitation coil 32(A) and the B-phase excitation coil 32(B) wound on the magnetic poles of the stator units 31a to 31d, and which corresponds to change in area of the magnetic poles opposing the salient poles of the corresponding rotor units 33a to 33d.

On the other hand, as shown in FIG. 18C, in the state in which the switched reluctance motor 30 is stopped, no electromotive force Ea is generated, and the DC constant power supply unit 10 supplies only the power of I²×R, which is the loss in the A-phase excitation coil 32(A) or the B-phase excitation coil 32(B). It is apparent from the foregoing that the switched reluctance motor drive system 1 according to the present embodiment can automatically supply and regenerate power simply by phase-shifting the switching of the current switching device 20 by 180° (electrical angle) without special control, regardless of either driving or regenerative braking (the polarity, positive or negative, of the speed electromotive force Ea), and regardless of the magnitude of the rotational speed (the magnitude of the speed electromotive force Ea).

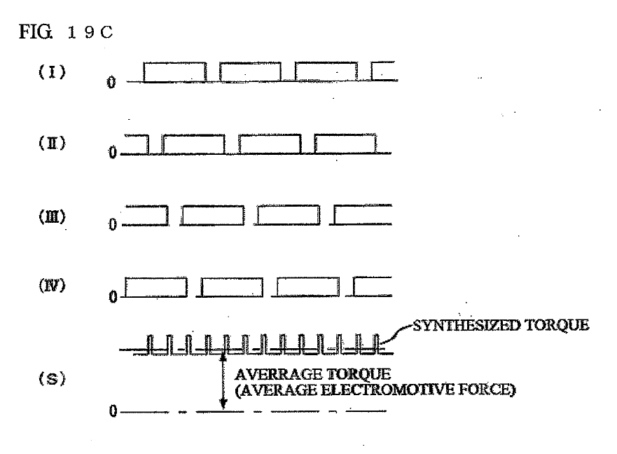

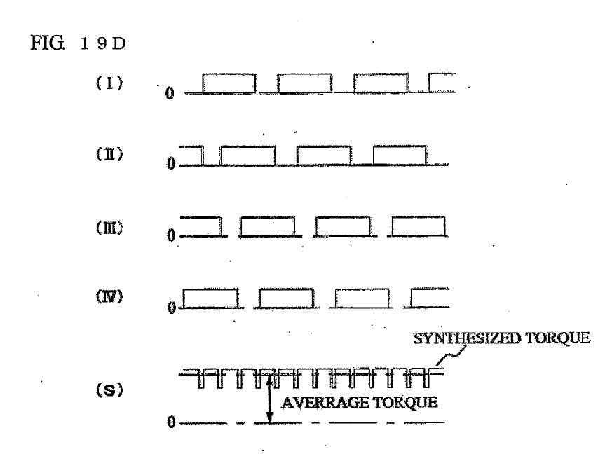

Referring now to FIGS. 19A to 19D, total torque and torque ripple of the switched reluctance motor 30 of the present embodiment with the 8-4-pole 4-stack structure will be described. FIG. 19A is a schematic diagram of four charts (I) to (IV) showing time changes of torques (or speed electromotive forces when driving the switched reluctance motor 30) of four phases (I) to (IV) generated corresponding to the respective four sets of stator units 31a to 31d and rotor units 33a to 33d (each chart or phase corresponding to one stator unit and one rotor unit) with the magnetic pole reduction factor K=0.75, as well as a chart (S) showing a time change of synthesized or total torque (electromotive force) of the torques (electromotive forces) of the four phases (I) to (IV). In each of the charts (I) to (IV) and (S), the horizontal axis is time, and the vertical axis is torque, which also applies to FIGS. 19B to 19D.

FIG. 19B is similar to FIG. 19A, except that the magnetic pole reduction factor K in FIG. 19B is K=0.5. It is apparent from FIGS. 19A and 19B that no ripple is present in the synthesized torque or synthesized electromotive force when the magnetic pole reduction factor K=0.75 (FIG. 19A), nor when the magnetic pole reduction factor K=0.5 (FIG. 19B). Note that when K=0.75, the value of the synthesized torque (synthesized electromotive force) is three times the peak value of the torque (electromotive force) in each of the four phases (I) to (IV), whereas the value of the synthesized torque is twice such peak value of the torque when K=0.5. Simply saying, the output of the switched reluctance motor 30 is reduced in proportion to the ratio between the different K values (2:3 in this case). However, an advantage of the magnetic pole reduction factor K=0.5 is that it reduces the width of the magnetic poles, making it possible to provide a large space for the excitation coils.

On the other hand, FIG. 19C is similar to FIG. 19A, except that the magnetic pole reduction factor K in FIG. 19C is set as K=0.8, which is slightly larger than K=0.75 in FIG. 19A as a reference, while FIG. 19D is similar to FIG. 19A, except that the magnetic pole reduction factor K in FIG. 19D is set as K=0.7, which is slightly smaller than K=0.75 in FIG. 19A as the reference. In each of FIGS. 19C and 19D, ripple is present in the synthesized torque (synthesized electromotive force). Note that assuming that the rotational speed of the switched reluctance motor 30 with the 8-4-pole 4-stack structure (refer to FIGS. 2A and 2B) is 6,000 rpm, the ripple frequency is 3,200 Hz, whereas assuming it to be 200 rpm (low speed), the ripple frequency is 107 Hz. The amplitude of the ripple in FIGS. 19C and 19D is equal to the torque (electromotive force) of one stack of stator unit and rotor unit.

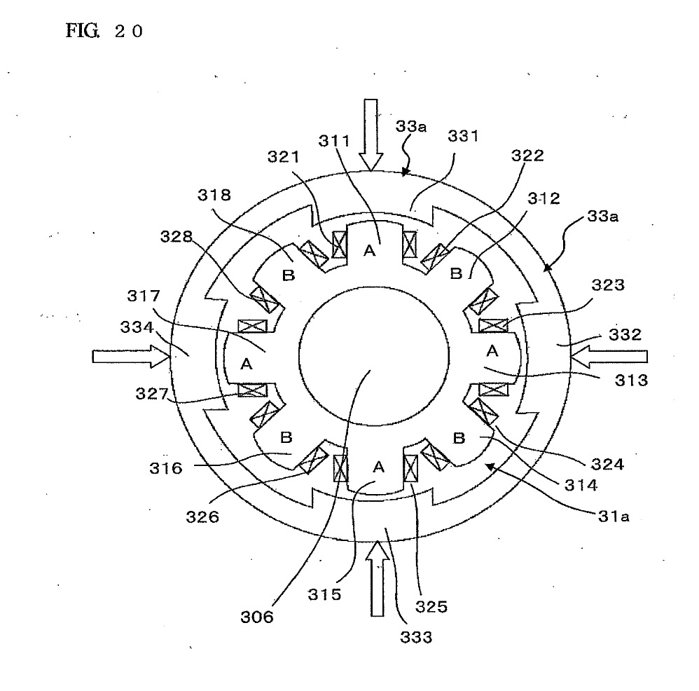

Referring to FIG. 20, the vibration and noise of the switched reluctance motor 30 will be described. FIG. 20 is a schematic view of the stator unit 31a (31b, 31c, 31d) and the rotor unit 33a (33b, 33c, 33d) with the 8-4-pole structure according to the present embodiment. FIG. 20 shows, by the arrow, a force (attractive force) exerted on the rotor unit 33a when an excitation current flows in the A-phase excitation coil (32(A)) to excite the A-phase magnetic poles 311, 313, 315, 317. The switched reluctance motor 30 may be used with a value near the saturation level of the magnetic flux density of the core of the stator unit to allow the switched reluctance motor 30 to produce a large output even if the switched reluctance motor 30 is small and light. In this case, assuming that the magnetic flux density is 1.6 T, an attractive force of 102 N may be generated per 1 cm² area of the opposing magnetic poles. In this case, the magnetic poles with the A-phase excitation coil 32(A) are excited to exert uniform four-directional attractive force on the rotor 33 having a circular outer core structure. Similarly, when the magnetic poles with the B-phase excitation coil 32(B) are excited, uniform four-directional attractive force is exerted on the rotor 33. Thus, uniform four-directional attractive force is always exerted on the rotor 33, so that the vibration and noise are considered to hardly occur when driving the switched reluctance motor 30.

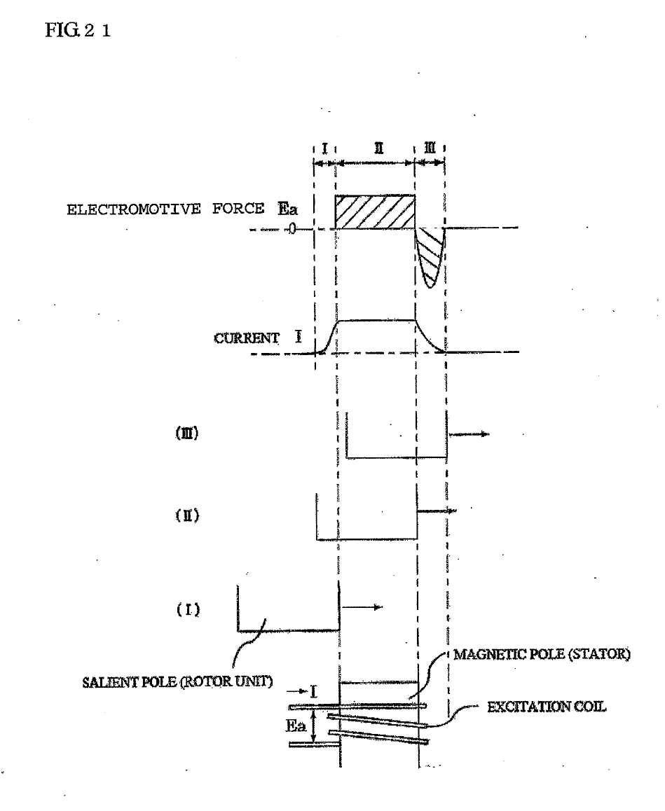

FIG. 21 is a schematic view showing one magnetic pole (311 to 318) of one stator unit (31a to 31d) and one salient pole (331 to 334) of one rotor unit (33a to 33d) for explaining effective power recovery to the DC constant current power supply unit 10 in the embodiment described above in which the width of the salient pole of each rotor unit is larger than the width of the magnetic pole of each stator unit. As shown in FIG. 21, based on the relative position of the salient pole to the magnetic pole, three periods (states) (I), (II), (III) can be considered with the width of the salient pole larger than the width of the magnetic pole (in which the width of the salient pole can be 25% larger than width of the magnetic pole in the case of the 8-4-pole 4-stack structure). FIG. 21 also shows a waveform of current I supplied to the excitation coil (321 to 328) by the constant current flip-flop circuit (20a to 20d) as well as electromotive force Ea. In period (I), the current increases from 0 (zero), and the current I is constant in period (II), while the current I decreases in period (III).

The electromotive force Ea in periods (I), (II), (III) can be expressed by the following equations:

In period (I), the electromotive force is:

Ea=0

since the current increases while the magnetic flux L in the excitation coil does not change.

In period (II), the electromotive force is:

$$Ea = I \frac{d L}{d t} ( constant )$$

since the current is constant while the magnetic flux increases linearly.

In period (III), the electromotive force is:

$$Ea = L \frac{d I}{d t} ( negative )$$

since the current decreases while the magnetic flux L does not change.

Each of energy W₁ in period (I), energy W₂ in period (II) and energy W₃ in period (III) can be calculated by multiplying the product of the electromotive force Ea and the current I in each period (Δt):

In period (I), Ea×I=0 so that:

W₁=0 [J]

In period (II):

$${W}_{2} = {\int }_{0}^{Δ t} Ea \cdot I d t = {\int }_{0}^{Δ t} I \frac{d L}{d t} \cdot Idt = {\int }_{0}^{L} {I}^{2} d L = {I}^{2} L \qquad [ J ]$$

In period (III):

$${W}_{3} = {\int }_{0}^{Δ t} Ea \cdot I d t = {\int }_{0}^{Δ t} L \frac{d I}{d t} \cdot Idt = L {\int }_{I}^{0} I d I = - \frac{1}{2} {I}^{2} L \qquad [ J ]$$

It is understood from the above that the energy supplied from the power supply unit in period (II) is I²L [J], and that half of the supplied energy is used for driving, while the other half is once stored in the magnetic circuit and then becomes negative in polarity in period (III) so as to be recovered to the power supply unit.

As understood from the above, the switched reluctance motor drive system of the present embodiment can efficiently recover the energy stored in the magnetic field to the power supply unit 10 under the conditions: that (1) the width of the salient pole of the rotor unit is larger than the width of the magnetic pole of the stator unit (in which the former can be 25% larger than the latter in the case of the 8-4-pole 4-stack structure); and (2) a rectangular-wave current is supplied at a proper timing to the magnetic poles of the stator unit by the flip-flop circuit (20a to 20d) from the DC constant current power supply unit 10. A conventional switched reluctance motor resisting torque does not effectively recover energy stored in a magnetic filed, which causes resisting toque, which in turn causes torque ripple, vibration and noise. In contrast, the switched reluctance motor according to the present embodiment in principle can recover 100% of the energy by using the DC constant current power supply unit 10 and the flip-flop circuit (20a to 20d).

As described above, in the switched reluctance motor drive system 1 according to the embodiment of the present invention, a constant DC rectangular-wave current is sequentially supplied, at predetermined timings (predetermined shifted timings), to the A-phase excitation coil 32(A) and the B-phase excitation coil 32(B) wound alternately on every other one of the eight magnetic poles (thus on the four magnetic poles) of each of the four stator units 31a to 31d forming the stator 31. Thus, the four salient poles of each of the four rotor units 33a to 33d forming the rotor 33, which is arranged outside the stator 31, are sequentially attracted by the excited magnetic poles of the corresponding stator units 31a to 33d so as to rotate the rotor 33, so that it is possible to efficiently drive the switched reluctance motor 30 with little torque ripple and noise.

Further, when driving the switched reluctance motor 30, the supply of the constant DC rectangular-wave current to the A-phase excitation coil 32(A) and the B-phase excitation coil 32(B) wound on the two sets of four magnetic poles, respectively, of the four stator units 31a to 31d forming the stator 31 is alternately switched. On the other hand, when braking the switched reluctance motor 30, it is possible to feed back, to the DC constant current power supply unit 10, a current which is superimposed on the constant DC current supplied to the A-phase excitation coil 32(A) and the B-phase excitation coil 32(B) wound on the magnetic poles of the stator units 31a to 31d, and which corresponds to change in area of the magnetic poles opposing the salient poles of the rotor units 33a to 33d. Thus, it is not only possible to drive the switched reluctance motor 30, but also to recover regenerative power.

It is to be noted that the present invention is not limited to the above embodiment, and various modifications are possible within the spirit and scope of the present invention. For example, although the switched reluctance motor 30 according to the embodiment of the present invention has an 8-4-pole 4-stack structure, the number of poles can be an arbitrary multiple of 4 such as 4, 8, 12, 16, 20 or so on (the number of salient poles can be an arbitrary multiple of 2 such as 2, 4, 7, 8, 10 and so on), while the number of stacks can be an arbitrary number more than 1 such as 2, 3, 4 or so on. Regarding the number of magnetic poles, note (1) that as the number of magnetic poles increases, the width of the magnetic poles can be reduced while the output generated by the magnetic poles is maintained the same, which reflects on the core or yoke and leads to a reduction in the size and weight of the switched reluctance motor 30, and (2) that the minimum number of magnetic poles, 4 (minimum number of salient poles, 2), may cause the attractive force to exert a very high pressure on the core (outer core), or less uniformity of the attractive force, which may cause vibration and noise, so that the number of magnetic poles is preferably 8 or larger (the number of the salient poles is preferably 4 or larger) for higher uniformity of the attractive force, and less vibration and noise.

Regarding the number of stacks, note (1) that an increase in the number of stacks is advantageous in terms of commutation overvoltage and high speed rotation since the reactance of the excitation coil of one phase decreases in inverse proportion to the square of the number of stacks, (2) that an increase in the number of stacks may cause a corresponding increase in the number of current switching circuits which may cause an increase in cost and semiconductor loss, and (3) that the minimum number of stacks, 1, can cause the existence of a zero point of starting force. The number of magnetic poles and the number of stacks can be determined by considering these factors. Finally, note that the switched reluctance motor drive system 1 described above can also be used as a power generation system to recover power by rotating the supporting shaft 306 (rotor 33) of the switched reluctance motor 30 with an external force (such as a driving force of external sources of power such as wind power or other natural powers).

The present invention has been described above using presently preferred embodiments, but such description should not be interpreted as limiting the present invention. Various modifications will become obvious, evident or apparent to those ordinarily skilled in the art, who have read the description. Accordingly, the appended claims should be interpreted to cover all modifications and alterations which fall within the spirit and scope of the present invention.

1. A regenerative switched reluctance motor comprising a stator and a rotor surrounding the stator,
wherein the rotor comprises a plurality of coaxially stacked rotor units,
wherein the stator comprises a plurality of coaxially stacked stator units facing and corresponding to the plurality of rotor units,
wherein each of the plurality of rotor units comprises 2n (n: integer) salient poles arranged at predetermined angular intervals,
wherein each of the plurality of stator units comprises 4n magnetic poles arranged at predetermined angular intervals such that the magnetic poles of each of the plurality of stator units and the salient poles of the corresponding each of the rotor units form a predetermined gap therebetween,
wherein a first excitation coil is wound on every other one of the 4n magnetic poles of each of the plurality of stator units, while a second excitation coil is wound on the remaining magnetic poles thereof, and
wherein the plurality of rotor units are sequentially shifted by a predetermined angle in angular position relative to the plurality of stator units.

2. The switched reluctance motor according to claim 1,
wherein n is at least 2, so that each of the plurality of rotor units has at least 4 salient poles, while each of the plurality of stator units has at least 8 magnetic poles.

3. The switched reluctance motor according to claim 2,
wherein the predetermined angle is a quotient of an angular pitch of the magnetic poles of each of the plurality of stator units divided by the number of the rotor units.

4. The switched reluctance motor according to claim 3,
wherein the plurality of rotor units are in the same angular position.

5. The switched reluctance motor according to claim 3,
wherein the plurality of stator units are in the same angular position.

6. The switched reluctance motor according to claim 2,
wherein the plurality of rotor units are in the same angular position.

7. The switched reluctance motor according to claim 2,
wherein the plurality of stator units are in the same angular position.

8. The switched reluctance motor according to claim 1,
wherein the predetermined angle is a quotient of an angular pitch of the magnetic poles of each of the plurality of stator units divided by the number of the rotor units.

9. The switched reluctance motor according to claim 8,
wherein the plurality of rotor units are in the same angular position.

10. The switched reluctance motor according to claim 8,
wherein the plurality of stator units are in the same angular position.

11. The switched reluctance motor according to claim 1,
wherein the plurality of rotor units are in the same angular position.

12. The switched reluctance motor according to claim 1,
wherein the plurality of stator units are in the same angular position.

13. The switched reluctance motor according to claim 1,
wherein the width of each of the salient poles of each of the plurality of rotor units in the direction of rotation is set to be larger than the width of each of the magnetic poles of the corresponding each of the stator units.

14. A switched reluctance motor drive system comprising a regenerative switched reluctance motor comprising a stator and a rotor surrounding the stator,
wherein the rotor comprises a plurality of coaxially stacked rotor units,
wherein the stator comprises a plurality of coaxially stacked stator units facing and corresponding to the plurality of rotor units,
wherein each of the plurality of rotor units comprises 2n (n: integer) salient poles arranged at predetermined angular intervals,
wherein each of the plurality of stator units comprises 4n magnetic poles arranged at predetermined angular intervals such that the magnetic poles of each of the plurality of stator units and the salient poles of the corresponding each of the rotor units form a predetermined gap therebetween,
wherein a first excitation coil is wound on every other one of the 4n magnetic poles of each of the plurality of stator units, while a second excitation coil is wound on the remaining magnetic poles thereof, and
wherein the plurality of rotor units are sequentially shifted by a predetermined angle in angular position relative to the plurality of stator units,
the switched reluctance motor drive system further comprising:
a DC constant current power supply unit having multiple output terminals to output a constant DC current from one of the multiple output terminals;
a plurality of current switching circuits which are provided respectively corresponding to the plurality of stator units, and each of which comprises a first current path and a second current path to be switched; and
switch control means for controlling the plurality of current switching circuits so as to alternately turn on the first current path and the second current path of each of the plurality of current switching circuits,
wherein the plurality of current switching circuits are series-connected while the first current path and the second current path of each of the plurality of current switching circuits are respectively connected in series with the first excitation coil and the second excitation coil of the corresponding one of the plurality of stator units,
wherein the DC constant current power supply unit, the plurality of current switching circuits and the switched reluctance motor are connected so that the constant DC current output from the one of the multiple output terminals of the DC constant current power supply unit is input to the first and second current paths of one of the series-connected current switching circuits, which is located at the first stage of the current switching circuits, and flows through the first excitation coil connected to the first current path and the second excitation coil connected to the second current path of another one of the series-connected current switching circuits, which is located at the final stage of the current switching circuits, and is then fed back to another one of the multiple output terminals, and
wherein the switch control means alternately performs on/off operations of the first and second current paths of each of the plurality of current switching circuits according to the angular position of the rotor of the switched reluctance motor so as to allow a current to alternately flow in the first excitation coil and the second excitation coil, and controls each of the plurality of current switching circuits so as to shift timing of the on/off operations of the first and second current paths, between when driving the switched reluctance motor and when braking the switched reluctance motor, by a time during which the rotor is rotated by an angle corresponding to an electrical angle of 180°.

15. The switched reluctance motor according to claim 14,
wherein the current to alternately flow in the first excitation coil and the second excitation coil is a rectangular-wave current.

16. The switched reluctance motor according to claim 14,
wherein n is at least 2, so that each of the plurality of rotor units has at least 4 salient poles, while each of the plurality of stator units has at least 8 magnetic poles.

17. The switched reluctance motor according to claim 14,
wherein the predetermined angle is a quotient of an angular pitch of the magnetic poles of each of the plurality of stator units divided by the number of the rotor units.

18. The switched reluctance motor according to claim 14,
wherein the plurality of rotor units are in the same angular position.

19. The switched reluctance motor according to claim 14,
wherein the plurality of stator units are in the same angular position.

20. The switched reluctance motor according to claim 14,
wherein the width of each of the salient poles of each of the plurality of rotor units in the direction of rotation is set to be larger than the width of each of the magnetic poles of the corresponding each of the stator units.
